(19) United States
(12) Patent Application Publication
(10) Pub. No.: US 2015/0022761 A1
(43) Pub. Date: Jan. 22, 2015

(54) LIGHT GUIDE PLATE TRANSFER MOLDING METHOD, LIGHT GUIDE PLATE, AND PLANAR LIGHT SOURCE APPARATUS

(71) Applicant: Gouo Kurata, Saitama (JP)

(72) Inventor: Gouo Kurata, Saitama (JP)

(21) Appl. No.: 14/306,376

(22) Filed: Jun. 17, 2014

(30) Foreign Application Priority Data
Jul. 22, 2013 (JP) 2013-151980

(51) Int. Cl. F21V 8/00; B29C 59/02; B29C 59/04; B29D 11/00

(52) U.S. Cl. CPC G02B 6/0036; B29D 11/00663; B29C 59/022; B29C 59/04; B29L 2011/0075
USPC 349/65; 362/617; 362/606; 362/613; 264/1.24; 425/385; 425/363

(57) ABSTRACT

A light guide plate transfer molding method for performing transfer molding of a light guide plate using a first mold and a second mold, includes performing, on a resin material, transfer molding of a first pattern and a second pattern that are provided on a transfer face of the first mold. The first pattern changes with a specific interval P serving as one period. The second pattern changes with one or two or more periods that correspond to 1/Na of the interval P. Na is a positive integer that satisfies Na≦m, m being a specific positive integer.

### FIELD

The present invention relates to a light guide plate transfer molding method, a light guide plate, and a planar light source apparatus. Specifically, the present invention relates to a light guide plate transfer molding method, a structure of a mold used in the transfer molding method, and a light guide plate transfer molding apparatus. Also, the present invention relates to a light guide plate manufactured using a transfer molding method, and a planar light source apparatus, a liquid crystal display apparatus, and a mobile device that include the light guide plate.

### BACKGROUND

There are known to be conventional transfer molding apparatuses that perform transfer molding of minute relief patterns by using transfer plates to apply heat and pressure to a resin film (e.g., see JP 2005-310286A).

In the case of using this kind of transfer molding apparatus to attempt to manufacture a light guide plate that has periodic patterns on both its upper and lower faces, an issue arises compared with the case of using an injection molding apparatus. That is to say, unlike the case of using an injection molding apparatus, with a transfer molding apparatus, the patterns for the upper and lower faces easily become misaligned.

With an injection molding apparatus, both molds are guided and positioned using a tie bar and a guide pin, and therefore there is no risk of misalignment occurring between the mold pattern for the upper face and the mold pattern for the lower face. In contrast to this, with a transfer molding apparatus, the patterns are added on the upper and lower faces of the resin sheet by sandwiching the resin sheet from above and below using upper and lower molds. However, the molds used in transfer molding are smaller in area than the resin sheet, and thus the upper and lower molds perform molding by sandwiching a resin sheet that is larger in area therebetween. For this reason, it is not possible to install a tie bar or a guide pin between the upper and lower molds, and the positions of the molds easily become misaligned. Also, the molds used in the transfer molding apparatus are thin and low in rigidity, and therefore their positions easily become misaligned when pressed against the resin sheet.

FIG. 1 is a schematic diagram of a planar light source apparatus 11 that includes a light guide plate 12 having periodic patterns, and multiple light sources 13 that are arranged at a constant interval P, FIG. 2A is a top view of the planar light source apparatus 11, and FIG. 2B is a bottom view of the planar light source apparatus 11. In the light guide plate 12, a light introduction portion 14 that is approximately wedge-shaped is integrally molded so as to be continuous with the end portion of a light guide plate body 15 that is planar in shape. The light sources 13 are aligned at a constant pitch P so as to oppose the end face of the light introduction portion 14, or in other words, a light receiving face 16 of the light guide plate 12 (although the figure shows two light sources, a larger number of light sources are normally used). An inclined face 17 is formed on the upper face of the light introduction portion 14, and prism-shaped first shapes 18 are provided on the inclined face 17. The cross-sectional shapes of the first shapes 18 change gradually according to the distance from an optical axis of a light source 13. Second shapes 19 are formed on the lower face of the light guide plate 12.

The first shapes 18 are optical shapes for minimizing light leakage from the inclined face 17 by changing the direction characteristic of light that has entered the light guide plate 12. For example, the first shapes 18 are V-groove shapes that extend along the inclined face 17. The first shapes 18 are symmetrical with respect to an optical axis of a light source 13 as viewed from a direction perpendicular to the upper face of the light guide plate 12, and it is possible for the cross-sectional shapes of the first shapes 18 to change, it is possible for groove angles of the first shapes 18 to change, and it is possible for the rotational angles of the grooves of the first shapes 18 to change according to the distance from the optical axis of a light source 13. The first shapes 18 are provided such that the same shape is repeated with a pitch that is the same as the alignment pitch P of the light sources 13.

The second shapes 19 are shapes that reflect light that is guided from the light introduction portion 14 to the light guide plate body 15, and cause the light to be emitted from the upper face of the light guide plate body 15 (light emission face) to the exterior. The second shapes 19 are distributed at a relatively low density at locations in front of the light sources where light intensity is high, and the second shapes 19 are distributed at a relatively high density at locations between light sources where light intensity is low. This reduces luminance unevenness. The second shapes 19 are also arranged symmetrically with respect to the optical axis of a light source 13 as viewed from a direction perpendicular to the upper face of the light guide plate 12, and the arrangement of the second shapes 19 repeats in the width direction at an interval that is the same as the alignment pitch P of the light sources 13 as viewed from a direction perpendicular to the upper face of the light guide plate 12.

In the case of performing transfer molding of this kind of light guide plate 12, the molding pattern for the upper face and the molding pattern for the lower face sometimes become misaligned in the width direction. FIGS. 3A and 3B show the first shapes 18 and the second shapes 19 when they are mutually misaligned in the width direction. As shown in FIG. 3A, when the first shapes 18 that have been molded on the upper face of a light guide plate 33 are used as a reference to arrange a light source 13, the axis of symmetry for the second shapes 19 (the axis that is to coincide with the optical axis) becomes misaligned with the optical axis of the light source 13 on the lower face of the light guide plate 12 as shown in FIG. 3B. For this reason, the high-intensity light in front of the light source is guided to a location where the density of the second shapes 19 is high, and the light is emitted with a high luminance at this portion. On the other hand, in the low-light-intensity region between light sources, light is guided to areas where the density of the second shapes 19 is low, and the luminance in this portion decreases. As a result, luminance unevenness occurs in the light emission face of the light guide plate 12.

In contrast, in the case of arranging the light sources 13 so as to coincide with the second shapes 19 on the lower face of the light guide plate 12, the first shapes 18 on the upper face and the optical axes of the light sources 13 become misaligned, and therefore light leakage from the inclined face 17 increases.

JP 2005-310286A is an example of background art.

### SUMMARY

One or more embodiments of the present invention provides a transfer molding method in which position misalignment at the time of molding between periodic patterns is not likely to be a problem in a transfer molding method for a light guide plate having two or more types of periodic patterns (shapes). One or more embodiments of the present invention provides a light guide plate and a planar light source apparatus in which position misalignment between the periodic patterns at the time of molding is not likely to occur.

A light guide plate transfer molding method according to one or more embodiments of the present invention is a transfer molding method for performing transfer molding of a light guide plate using a first mold and a second mold, the method comprising:

a transfer molding step of, on a resin material, performing transfer molding of a first pattern and a second pattern that are provided on a transfer face of the first mold, and the first pattern changing with a specific interval P serving as one period, and the second pattern changing with one or two or more periods that correspond to 1/Na of the interval P, where Na is a positive integer that satisfies Na≦m, m being a specific positive integer.

In the light guide plate transfer molding method according to one or more embodiments of the present invention, transfer molding of a first pattern whose period is equal to a specific interval P, and of a second pattern that has a relatively large period is performed using the same mold, or in other words, the first mold, and therefore, even if the relative positions of the first mold and the second mold become misaligned, position misalignment does not occur between the first pattern and the second pattern formed by transfer molding on the light guide plate. Accordingly, luminance unevenness is not likely to occur in the light guide plate due to position misalignment between the patterns on the upper and lower face of the light guide plate, and loss of light due to light leakage in the process of guiding light is also not likely to increase.

In the transfer molding of the light guide plate, generally, at least the first mold of the first mold and the second mold has a transfer face, and the transfer face is smaller in area than the resin material. Because of this, the positions of the first mold and the second mold easily become misaligned. Accordingly, with the light guide plate transfer molding method according to one or more embodiments of the present invention, an extremely favorable result can be obtained with this kind of light guide plate transfer molding.

A light guide plate transfer molding method according to one or more embodiments of the present invention includes a transfer molding step of, on another surface of the resin material, performing transfer molding of a third pattern and/or a fourth pattern that are provided on the transfer face of the second mold, the third pattern changing with one or two or more periods that correspond to 1/Nb of the interval P, where Nb is a positive integer that satisfies Nb≧m+1, m being a specific positive integer, and the fourth pattern not having periodicity. Thus, a pattern (shape) with a relatively large period as on the first mold is not provided on the second mold, and the third pattern that is aligned with a relatively small period and/or the fourth pattern that has no periodicity are provided on the second mold, and therefore, even if the relative positions of the first and second molds become misaligned, a reduction in luminance caused by luminance unevenness or light leakage are not likely to occur in the light guide plate.

In the light guide plate transfer molding method according to one or more embodiments of the present invention, the periods of the first pattern and the second pattern that are provided on the transfer face may be the same. Also, the specific positive integer m may be 1. Both are cases in which the period of the second pattern is equal to the specific interval P.

A light guide plate transfer molding method according to one or more embodiments of the present invention comprises:

a resin material supply step of supplying resin material to a position between a first mold and second mold that are arranged opposing each other; and

a sandwiching step of sandwiching the resin material between the two molds in a state in which the first mold and the second mold are pressed against the respective faces of the resin material.

This is a method of performing transfer molding by sandwiching resin material between the first mold and the second mold.

A light guide plate transfer molding method according to one or more embodiments of the present invention comprises:

a resin material supply step of sequentially supplying resin material to a position opposing a first mold and a position opposing a second mold;

a first pressing step of causing the first mold to be pressed against the resin material that was supplied to the position opposing the first mold, and

a second pressing step of causing the second mold to be pressed against the resin material that was supplied to the position opposing the second mold.

This is a method of sequentially performing transfer molding on the two faces of resin material by causing the first mold and the second mold to be pressed against the resin material.

The light guide plate transfer molding method according to one or more embodiments of the present invention may be such that the first pattern and the second pattern directly undergo transfer molding on a sheet-like resin material (resin sheet). Also, the first pattern and the second pattern may undergo transfer molding on resin that has been applied to the surface of a resin sheet.

Note that the specific interval P is equal to the period with which the intensity of light incident on a light guide plate changes, for example.

A light guide plate mold structure according to one or more embodiments of the present invention comprises:

a first mold and a second mold,

wherein a first pattern that changes with a specific interval P serving as one period, and a second pattern that changes with one or two or more periods that correspond to 1/Na of the interval P, where Na is a positive integer that satisfies Na≦m, m being a specific positive integer, are provided on a transfer face formed on the first mold.

In the light guide plate mold structure according to one or more embodiments of the present invention, transfer molding of a first pattern whose period is equal to a specific pitch P, and of a second pattern that has a relatively large period is performed using the same mold, or in other words, the first mold, and therefore, even if the relative positions of the first mold and the second mold become misaligned, position misalignment does not occur between the first pattern and the second pattern formed by transfer molding on the light guide plate. Accordingly, luminance unevenness is not likely to occur in the light guide plate due to position misalignment between the patterns on the upper and lower face of the light guide plate, and luminance reduction due to light leakage in the process of guiding light is also not likely to occur.

A light guide plate mold structure according to one or more embodiments of the present invention is such that a third pattern that changes with one or two or more periods that correspond to 1/Nb of the interval P, where Nb is a positive integer that satisfies Nb≧m+1, m being a specific positive integer, and/or a fourth pattern that does not have periodicity are provided on a transfer face formed on the second mold. Thus, a pattern (shape) with a relatively large period as on the first mold is not provided on the second mold, and the third pattern that is aligned with a relatively small period and/or the fourth pattern that has no periodicity are provided on the second mold, and therefore, even if the relative positions of the first and second molds become misaligned, a reduction in luminance caused by luminance unevenness or light leakage are not likely to occur in the light guide plate.

A light guide plate transfer molding apparatus according to one or more embodiments of the present invention comprises the light guide plate mold structure according to the present invention. In the light guide plate transfer molding apparatus according to one or more embodiments of the present invention, the mold structure for the light guide plate according to one or more embodiments of the present invention is used, and therefore, even if the relative positions of the first mold and the second mold become misaligned, position misalignment between the first pattern and the second pattern that are to undergo transfer molding does not occur in the light guide plate. Accordingly, luminance unevenness is not likely to occur in the light guide plate due to position misalignment between the patterns on the upper and lower face of the light guide plate, and luminance reduction due to light leakage in the process of guiding light is also not likely to occur.

The light guide plate transfer molding apparatus according to one or more embodiments of the present invention is not limited to using the plate-shaped first mold and second mold, and it is possible to provide the first mold on the outer circumferential face of a first roller and to provide the second mold on the outer circumferential face of a second roller.

A light guide plate according to one or more embodiments of the present invention is a light guide plate that has a light receiving face on one end face that receives light, and has a light emission face on a main face that emits light received from the light receiving face to the exterior,

wherein a first pattern that appears on the surface in a cross-section taken parallel to the light receiving face and changes with a specific interval P serving as one period, and a second pattern that appears on the surface in a cross-section taken parallel to the light receiving face and changes with one or two or more periods that correspond to 1/Na of the interval P, where Na is a positive integer that satisfies Na≦m, m being a specific positive integer, are provided on one of the upper face and the lower face in the vicinity of the light receiving face.

In the light guide plate according to one or more embodiments of the present invention, a first pattern with a period that is equal to the specific interval P and a second pattern having a relatively large period are provided on the same face of the light guide plate, and therefore, even if the relative positions of the pattern (shapes) molded on the upper face of the light guide plate and the pattern (shapes) molded on the lower face of the light guide plate become misaligned, position misalignment does not occur between the first pattern and the second pattern. Accordingly, luminance unevenness is not likely to occur in the light guide plate due to position misalignment between the patterns on the upper and lower face of the light guide plate, and loss of light due to light leakage in the process of guiding light is also not likely to increase.

In a light guide plate according to one or more embodiments of the present invention, a third pattern that appears on the surface in a cross-section taken parallel to the light receiving face and changes with one or two or more periods that correspond to 1/Nb of the interval P, where Nb is a positive integer that satisfies Nb≧m+1, m being a specific positive integer, and/or a fourth pattern with no periodicity are provided on the other one of the upper face and the lower face. Thus, on the face opposite to the face of the light guide plate on which the first and second patterns are provided, patterns (shapes) with a relatively large period are not provided and the third pattern that is aligned with a relatively small period and/or the fourth pattern that has no periodicity are provided, and therefore, even if the relative positions of the patterns (shapes) formed on the upper and lower faces of the light guide plate become misaligned, luminance unevenness or a reduction in luminance caused by light leakage are not likely to occur in the light guide plate.

The planar light source apparatus according to one or more embodiments of the present invention is a planar light source apparatus comprising:

a plurality of light sources arranged at a constant interval; and

a light guide plate including a light receiving face on which light is received on one end face, and a light emission face that emits light received from the light receiving face to the exterior on a main face,

wherein a first pattern that appears on the surface of the light guide plate in a cross-section taken parallel to the light receiving face of the light guide plate changes with a specific interval P of the plurality of light sources serving as one period, and performs conversion of the direction characteristic of the light received from the light receiving face in the light guide plate from a direction characteristic in the thickness direction of the light guide plate into a direction characteristic inclined toward the width direction of the light guide plate, and

a second pattern that appears on the surface of the light guide plate in a cross-section taken parallel to the light receiving face of the light guide plate and changes with one or two or more periods that correspond to 1/Na of the arrangement interval P of the plurality of light sources, where Na is a positive integer that satisfies Na≦m, m being a specific positive integer,

are provided on one of the upper face and the lower face in the proximity of the light receiving face of the light guide plate.

In the planar light source apparatus according to one or more embodiments of the present invention, a first pattern with a period that is equal to the arrangement interval P of the light sources and a second pattern having a relatively large period are provided on the same face of the light guide plate, and therefore, even if the relative positions of the pattern (shapes) molded on the upper face of the light guide plate and the pattern (shapes) molded on the lower face of the light guide plate become misaligned, position misalignment does not occur between the first pattern and the second pattern. Accordingly, luminance unevenness is not likely to occur in the planar light source apparatus due to position misalignment between the patterns on the upper and lower face of the light guide plate, and loss of light due to light leakage in the process of guiding light is also not likely to increase.

In a planar light source apparatus according to one or more embodiments of the present invention, a third pattern that appears on the surface of the light guide plate in a cross-section taken parallel to the light receiving face of the light guide plate and changes with one or two or more periods that correspond to 1/Nb of the arrangement period P of the plurality of light sources, where Nb is a positive integer that satisfies Nb≧m+1, m being a specific positive integer, is provided on the other face of the upper face and the lower face of the light guide plate. Thus, on the face opposite to the face of the light guide plate on which the first and second patterns are provided, patterns (shapes) with a relatively large period are not provided and the third pattern that is aligned with a relatively small period is provided, and therefore, even if the relative positions of the patterns (shapes) formed on the upper and lower faces of the light guide plate become misaligned, luminance unevenness or a reduction in luminance caused by light leakage are not likely to occur in the planar light source apparatus.

In a planar light source apparatus according to one or more embodiments of the present invention, a fourth pattern that appears on the surface of the light guide plate in a cross-section taken parallel to the light receiving face of the light guide plate and has no periodicity is provided on the other one of the upper face and the lower face of the light guide plate. Thus, on the face opposite to the face of the light guide plate on which the first and second patterns are provided, the fourth pattern that has no periodicity is provided, and therefore, even if the relative positions of the patterns (shapes) formed on the upper and lower faces of the light guide plate become misaligned, luminance unevenness or a reduction in luminance caused by light leakage are not likely to occur in the planar light source apparatus.

In a planar light source apparatus according to one or more embodiments of the present invention, in a view from a direction perpendicular to the upper face of the light guide plate, the first pattern and the second pattern are provided in a region whose distance measured from the light receiving face is shorter than

3×P×\sqrt{n²−1}

In order to reduce the appearance of luminance unevenness, according to one or more embodiments of the present invention, the ratio Smax/Smin between the maximum value Smax and the minimum value Smin of the light intensity measured along the direction parallel to the light receiving face of the light guide plate is 1.02 or less, and for this purpose, it is sufficient that the first pattern and the second pattern are provided in that region.

In a planar light source apparatus of one or more embodiments of the present invention, in a view from a direction perpendicular to the upper face of the light guide plate, the first pattern and the second pattern are symmetrical with respect to the optical axis of each of the plurality of light sources within a range that is equal to the arrangement interval of the plurality of light sources. Thus, it may be possible to prevent the luminance from being uneven on the two sides of the optical axis of the light source.

In the planar light source apparatus according to one or more embodiments of the present invention, the period of the first pattern provided on the transfer face may be the same as the period of the second pattern. Also, the specific positive integer in may be 1. Both cases are cases in which the period of the second pattern is equal to the specific interval P.

Also, in the planar light source apparatus according to one or more embodiments of the present invention, a fifth pattern that is aligned with a constant period may be formed on the face on the side of the light guide plate on which the first pattern and the second pattern are provided. The period of the fifth pattern may be the light source alignment interval P divided by an integer. Alternatively, the fifth pattern may be distributed irregularly on the face on the side of the light guide plate on which the first pattern and the second pattern are provided.

In the planar light source apparatus according to one or more embodiments of the present invention, a light guide plate can be used that is constituted by a light introduction portion whose height dimension is the same as that of each of the plurality of light sources, and a light guide plate body that is thinner than the maximum thickness of the light introduction portion is provided so as to be continuous with the light introduction portion and emits received light to the exterior, and the light introduction portion has an inclined face that inclines as it extends from the face of a portion that is thicker than the light guide plate body to the end of the face of the light guide plate body, the inclined face being included on the face on the light emitting side of the light guide plate or on the face opposite thereto. Also, in this case, the inclined face of the light introduction portion may be provided on the face on the light emitting side of the light guide plate, the first pattern may be formed on at least a portion of the inclined face, and the second pattern may be formed on the light guide plate body.

Also, in the planar light source apparatus according to one or more embodiments of the present invention,

the first pattern may form a groove structure in which ridge lines and valley lines repeat alternatingly in the direction in which the plurality of light sources are aligned, and

the first pattern may include an inclined face connecting a ridge line among the ridge lines and one of the valley lines adjacent to the ridge line, and an inclined face connecting the ridge line and the other valley line adjacent to the ridge line, and in a view in a cross-section obtained by cutting parallel to the light receiving face, the inclined faces are asymmetrical with respect to a straight line that passes through the ridge line and is perpendicular to the light emission face, and at least one set of the asymmetrical portions having different shapes on both sides of the center of a light source may exist.

Also, in the planar light source apparatus according to one or more embodiments of the present invention, the rough density distribution of the second pattern is formed with a period at which the density is high at positions between the plurality of light sources when light is projected on the light receiving face. Accordingly, it may be possible to prevent the luminance of the planar light source apparatus from decreasing and darkening in regions between light sources.

Also, in the planar light source apparatus according to one or more embodiments of the present invention, a fifth pattern is provided on the light emission face, and the fifth pattern may be overlaid on at least a portion of the second pattern in a view from the side face direction of the light guide plate that is parallel to the light receiving face. In this case, the fifth pattern has a lenticular lens shape or a pattern shape. An oriented shape is an example of a pattern shape that serves as the fifth pattern. The oriented shape mentioned here refers to a relief pattern whose cross section is recessed or protruding, and is provided in order to improve the internal product quality by improving the luminance of the light guide plate or reducing luminance unevenness. The shape and arrangement of the alignment pattern can be selected as appropriate according to the extent of the orientation of the light.

The planar light source apparatus according to one or more embodiments of the present invention can be used as a backlight for a liquid crystal display apparatus. Also, the planar light source apparatus according to one or more embodiments of the present invention can be used as a backlight for a mobile device such as a mobile telephone or a mobile computer.

One or more embodiments of the present invention may include an appropriate combination of the above-described constituent elements, and many variations of the present invention are possible according to the combination of the constituent elements.

### BRIEF DESCRIPTION OF THE DRAWINGS

FIG. 1 is a schematic side view showing a conventional planar light source apparatus.

FIG. 2A is a top view of the planar light source apparatus shown in FIG. 1. FIG. 2B is a bottom view of the planar light source apparatus shown in FIG. 1.

FIGS. 3A and 3B are a top view and a bottom view of the planar light source apparatus in the case where shapes on the upper face and shapes on the lower face of a light guide plate have become misaligned.

FIG. 4A is a top view of the planar light source apparatus according to one or more embodiments of the present invention. FIG. 4B is a bottom view of the planar light source apparatus shown in FIG. 4A.

FIG. 5A is a top view showing the planar light source apparatus shown in FIG. 4A in the case where the arrangement of the shapes has been adjusted. FIG. 5B is bottom view of the planar light source apparatus shown in FIG. 5A.

FIG. 6A is a top view of the planar light source apparatus showing a different shape arrangement. FIG. 6B is a bottom view of the planar light source apparatus shown in FIG. 6A.

FIGS. 7A and 7B are perspective views from the upper face and the lower face of the planar light source apparatus according to Embodiment 1 of the present invention.

FIG. 8 is a schematic cross-sectional view of the planar light source apparatus shown in FIG. 7.

FIG. 9 is a cross-sectional view and partially enlarged views of a direction characteristic conversion pattern in the range of W shown in FIG. 7.

FIG. 10 is a diagram for describing the action of the direction characteristic conversion pattern shown in FIG. 9.

FIGS. 11A and 11B are a top view and a bottom view of the planar light source apparatus shown in FIG. 2. FIGS. 11C and 11D are a top view and a bottom view of the planar light source apparatus of Embodiment 1 of the present invention.

FIG. 12 is a cross-sectional view and partially enlarged views of a direction characteristic conversion pattern in which the cross-sectional shapes of pattern elements change according to the distance from a light source center.

FIG. 13 is a diagram for describing how to obtain the average angle of normal lines provided on pattern incline faces.

FIG. 14 is a cross-sectional view and partially enlarged views of a direction characteristic conversion pattern in which the cross-sectional shapes of pattern elements change according to the distance from the light source center while the apex angle is kept constant.

FIG. 15 is a schematic view for describing ranges in which second shapes are provided on the upper face of the light guide plate.

FIGS. 16A and 16B is a perspective views as viewed from above and a perspective view as viewed from below showing the planar light source apparatus according to a modified example of Embodiment 1 of the present invention.

FIG. 17 is a perspective view showing the planar light source apparatus according to another modified example of Embodiment 1 of the present invention.

FIGS. 18A and 18B are a perspective view as viewed from above and a perspective view as view from below showing the planar light source apparatus according to yet another modified example of Embodiment 1 of the present invention.

FIGS. 19A and 19B is a perspective view as viewed from above and a perspective view as viewed from below showing the planar light source apparatus according to yet another modified example of Embodiment 1 of the present invention.

FIG. 20 is a top view showing the planar light source apparatus according to another modified example of Embodiment 1 of the present invention.

FIGS. 21A and 21B are a top view and a bottom view of the planar light source apparatus according to yet another modified example of Embodiment 1 of the present invention.

FIGS. 22A and 22B are a perspective view as viewed from above and a perspective view as viewed from below showing the planar light source apparatus according to Embodiment 2 of the present invention.

FIGS. 23A and 23B are a perspective view as viewed from above and a perspective view as viewed from below showing the planar light source apparatus according to Embodiment 3 of the present invention.

FIG. 24 is a perspective view showing the direction characteristic conversion pattern formed on a projecting portion on the planar light source apparatus shown in FIG. 23A.

FIGS. 25A and 25B are a perspective view as viewed from above and a perspective view as viewed from below showing the planar light source apparatus according to a modified example of Embodiment 3 of the present invention.

FIG. 26 is a schematic front view showing a light guide plate forming apparatus according to Embodiment 4 of the present invention.

FIG. 27 is a partial exploded perspective view schematically showing a transfer molding apparatus shown in FIG. 26.

FIG. 28A is a partial plan view of an upper mold transfer plate shown in FIG. 27.

FIG. 28B is a partial plan view of a lower mold transfer plate shown in FIG. 27.

FIG. 29A is a schematic view of a partial cross-section of a mold portion shown in FIG. 27. FIG. 29B is a partially enlarged view thereof.

FIG. 30A is a diagram for describing a relationship between a semi-finished plate and first and second cutting tools. FIGS. 30B and 30C are diagrams for describing a relationship between the semi-finished plate and the first cutting tool.

FIG. 31 is a partial exploded perspective view showing the transfer molding apparatus according to Embodiment 5.

FIGS. 32A to 32F are diagrams for describing operations of plates in the transfer molding apparatus shown in FIG. 31.

FIG. 33A is a graph showing change in the elasticity modulus of a resin sheet accompanying temperature change in the resin sheet. FIG. 33B is a graph showing change in residual stress of a resin sheet accompanying temperature change in the resin sheet.

FIG. 34 is a graph showing a relationship between temperature and applied pressure in a mold of the transfer molding apparatus shown in FIG. 31.

FIGS. 35A to 35D are diagrams for describing operations of plates in the transfer molding apparatus according to Embodiment 6.

FIGS. 36A to 36C are diagrams for describing operations of plates in the transfer molding apparatus according to Embodiment 6.

FIGS. 37A to 37D are schematic diagrams for describing a method for forming a light introduction portion on a resin sheet according to another embodiment.

FIGS. 38A and 38B are schematic diagrams for describing methods for forming a light introduction portion on a resin sheet according to another embodiment.

FIGS. 39A and 39B are schematic diagrams for describing methods for forming the light introduction portion on a resin sheet according to another embodiment.

FIGS. 40A to 40D are partial schematic cross-sectional views of a transfer plate and a resin sheet according to another embodiment.

FIG. 41 is a schematic front view showing the transfer molding apparatus according to Embodiment 7.

FIGS. 42A and 42B are a plan view and a side view showing a pre-cut resin sheet molded by the transfer molding apparatus shown in FIG. 41.

FIGS. 43A and 43B are a plan view and a cross-sectional view of a resin sheet extruded from a profile extrusion molding machine. FIGS. 43C and 43D are a plan view and a cross-sectional view showing a pre-cut resin sheet molded by the transfer molding apparatus shown in FIG. 41.

FIG. 44A is a schematic front view showing the transfer molding apparatus according to Embodiment 8. FIG. 44B is a schematic diagram showing a pre-cut resin sheet molded by the transfer molding apparatus shown in FIG. 44A.

FIG. 45 is a schematic cross-sectional view showing a liquid crystal display apparatus according to Embodiment 9 of the present invention.

FIG. 46 is a schematic perspective view showing a mobile device according to Embodiment 10 of the present invention.

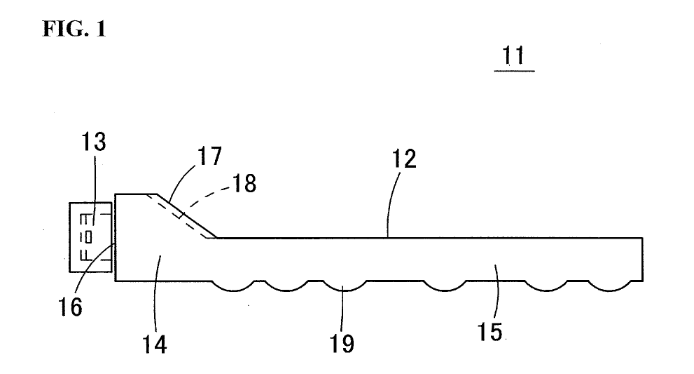

### DETAILED DESCRIPTION

Embodiments of the present invention will be described below with reference to the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. Note that the present invention is not limited to the embodiments below, and it is possible to change the design thereof in various ways that do not deviate from the gist of the present invention.

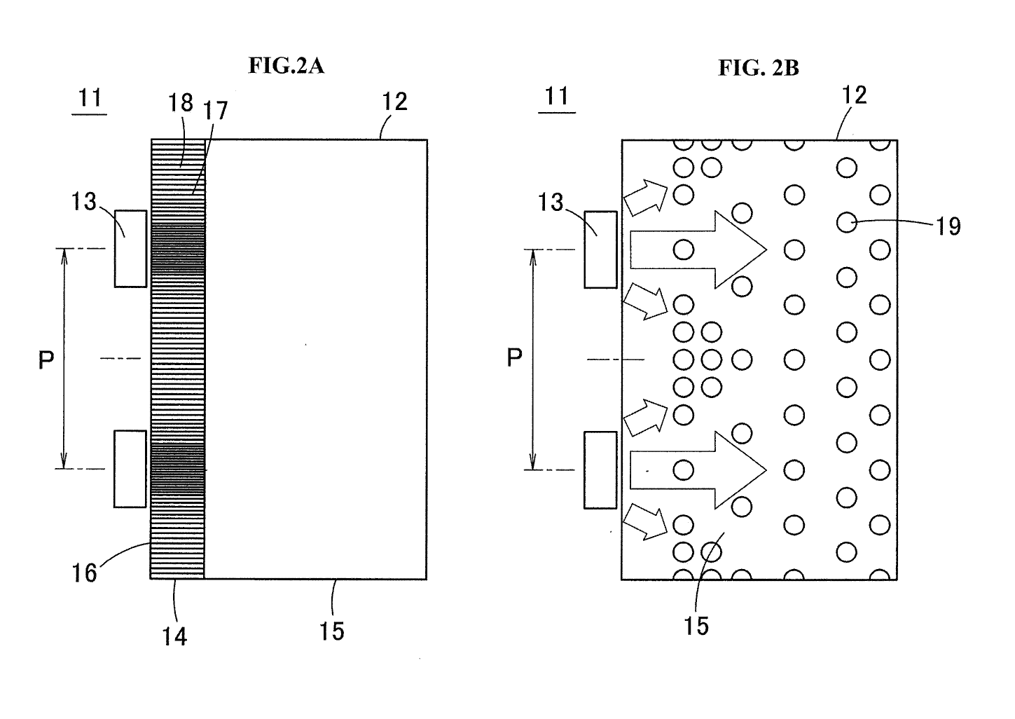

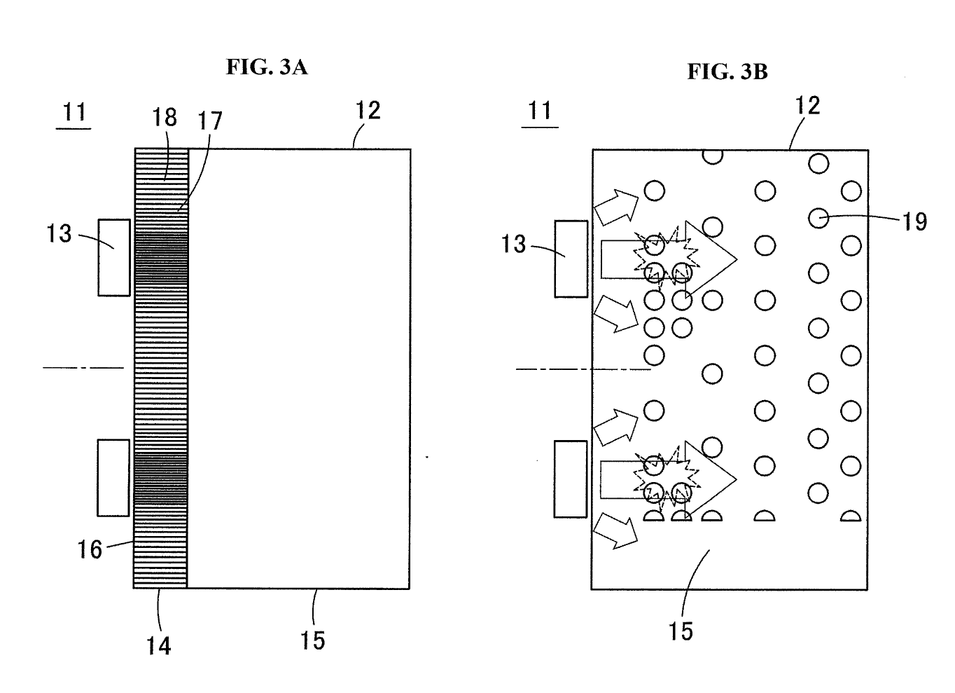

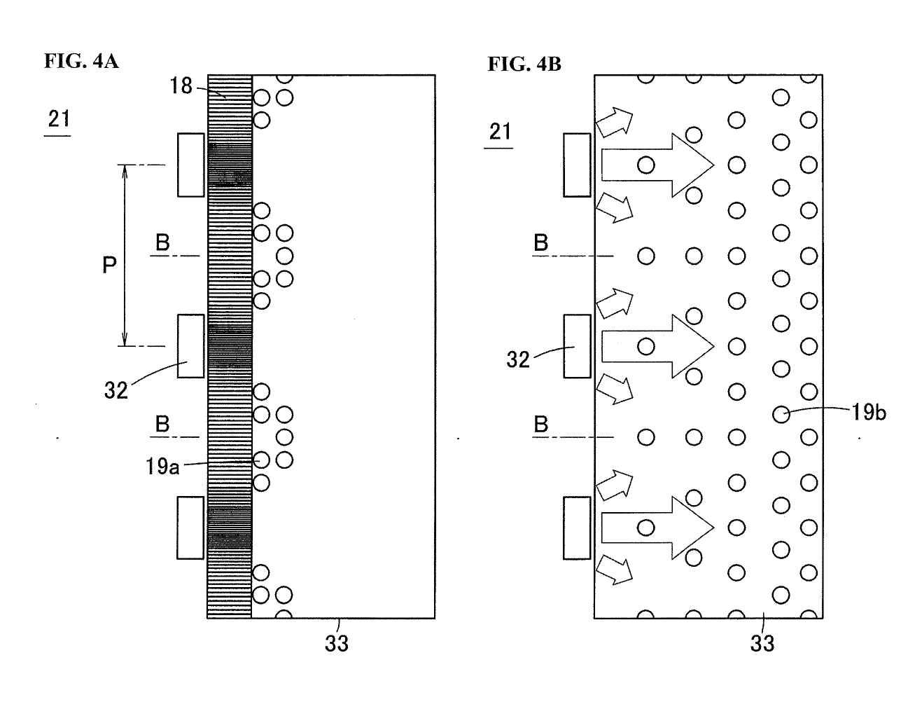

A planar light source apparatus according to Embodiment 1 of the present invention will be described below with reference to FIGS. 4A and 4B, 5A and 5B, and 6A and 6B. FIG. 4A is a top view of a planar light source apparatus 21 according to Embodiment 1 of the present invention. FIG. 4B is a bottom view of the planar light source apparatus 21 shown in FIG. 4A. The arrangement of the optical shapes on the planar light source apparatus 21 shown in FIGS. 4A and 4B has been redesigned based on the planar light source apparatus 11 that was shown in FIG. 2 as an example of the conventional technology.

With the planar light source apparatus shown in FIG. 2, in which multiple light sources are aligned with a constant pitch P, first shapes 18 on the upper face side are aligned in the width direction with the same pitch as the alignment pitch P of the light sources, and second shapes 19 on the lower face side are aligned in the width direction at one or two or more pitches corresponding to P/n. Here, n is a positive integer that is greater than or equal to 1, and the light guide plate includes groups of shapes having the same value for n and groups of shapes having different values for n.

With the planar light source apparatus 21 of one or more embodiments of the present invention, among the second shapes 19, shapes for which P/n≧P/m (i.e., n≦m) with respect to a positive integer m are formed on the upper face of the light guide plate, and patterns for which P/n≦P/(m+1) (i.e., n≧m+1) are formed on the lower face of the light guide plate. Here, m is an arbitrarily-set positive integer that is relatively small (e.g., m=1). Here, P is the alignment pitch of the light sources 32.

The arrangement of the optical shapes of the planar light source apparatus 21 shown in FIGS. 4A and 4B has been redesigned based on the planar light source apparatus 11 that was shown in FIG. 2 as an example of the conventional technology. That is to say, in the planar light source apparatus 21 shown in FIGS. 4A and 4B, among the second shapes 19 that are provided on the lower face of the light guide plate 12 of the planar light source apparatus 11 shown in FIGS. 2A and 2B, the second shapes 19 that are aligned in the width direction with the same pitch (n=1) as the alignment pitch P of the light sources are formed at corresponding positions on the upper face of the light guide plate 33 as a second pattern 19a, and the second shapes 19 that are aligned in the width direction with a pitch smaller than the alignment pitch P of the light sources 32 (n≧2) are left as-is on the lower face of the light guide plate 33 as a third pattern 19b.

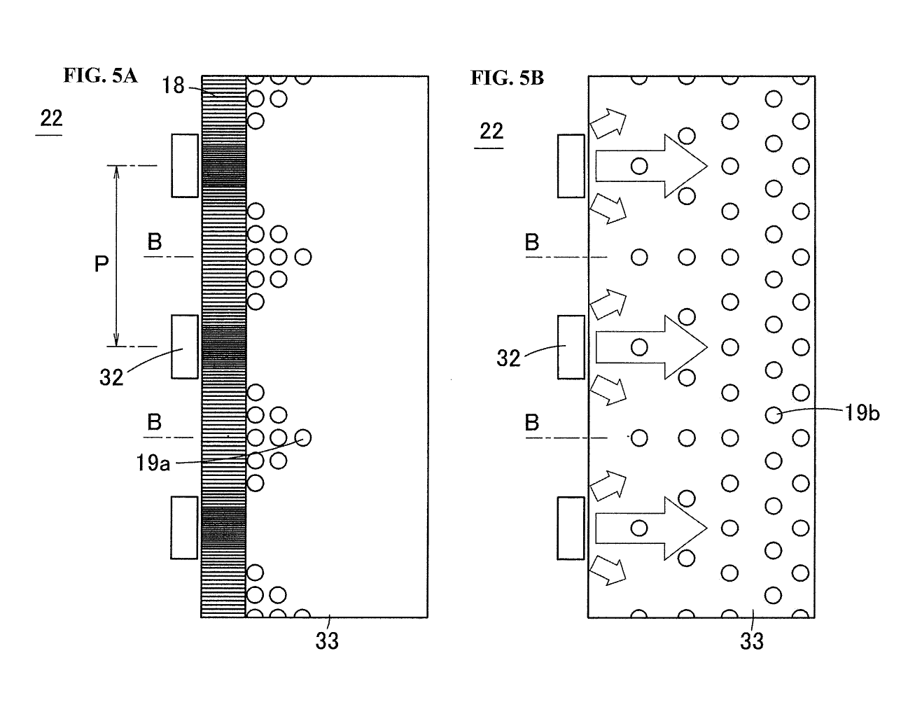

Also, in the planar light source apparatus 22 shown in FIGS. 5A and 5B, the second shapes 19 that are aligned with the same pitch as the alignment pitch P of the light sources, and a portion of the second shapes 19 that are aligned in the width direction with a pitch that is one-half of the alignment pitch P of the light sources 32 (n=2) in the planar light source apparatus 11 shown in FIG. 2 are formed as the second pattern 19a at opposing positions on the upper face of the light guide plate 33, and a portion of the second shapes 19 that are aligned in the width direction at pitches that are one-half or less of the arrangement pitch P of the light sources 32 (n≧2) are left as-is on the lower face of the light guide plate 33 as the third pattern 19b. In other words, shapes arranged at a pitch that is one-half or less of the alignment pitch P of the light sources 13 are provided as-is on the lower face of the light guide plate 12 as the third pattern 19b, and a portion of the second shapes 19 are furthermore provided redundantly on the upper face of the light guide plate 12 as well. Ultimately, on the upper face of the light guide plate 33, the second shapes 19 are aligned with a pitch equal to the alignment pitch P of the light sources 32 so as to form the second pattern 19a, and on the lower face of the light guide plate 33, the second shapes 19 are aligned at a pitch that is smaller than the alignment pitch P of the light sources 32 so as to form the third pattern 19b.

Also, the first shapes 18 change along the width direction of the light guide plate 33 and repeat the same shape at the same pitch as the alignment pitch P of the light sources 13 in the width direction of the light guide plate 33. Accordingly, the first shapes 18 are a first pattern that is aligned as-is at the same pitch as the alignment pitch P of the light sources 13.

With the planar light source apparatuses 21 and 22 shown in FIGS. 4 and 5, even if the first pattern 18 (first shapes) and the second pattern 19a on the upper face and the third pattern 19b on the lower face become misaligned in the width direction at the time of molding the light guide plate 33, no misalignment occurs between the second pattern 19a and the first pattern 18 that are provided on the upper face of the light guide plate 33. Accordingly, if the light sources 32 are arranged so as to coincide with the first pattern 18 and the second pattern 19a on the upper face, light is less likely to leak from the first pattern 18, and luminance unevenness caused by the second pattern 19a on the upper face is also less likely to occur. At this time, the third pattern 19b on the lower face will become misaligned with respect to the arrangement of the light sources 13, but since the pitch of the third shape 19b on the lower face is smaller than the alignment pitch P of the light sources 13, the misalignment will have little influence on the positional relationship between the light source 13 and the third pattern 19b, and luminance unevenness will be less likely to occur.

As can be understood from the description of the effects, the larger the integer m (boundary value) is, the smaller the influence of position misalignment between shapes on the lower face and the light sources 32 is. However, if m increases, the number of shapes provided on the upper face of the light guide plate 33 increases, thus making pattern design difficult. Also, there are cases where lenticular lenses or the like are provided on the external region of the first pattern 18 of the light guide plate 33 (light emission face). Because of this, if the second shapes 19 (second pattern 19a) that are provided on the upper face of the light guide plate 33 increase in number, there is a risk that the functionality of the lenticular lenses or the like will be inhibited. Accordingly, according to one or more embodiments of the present invention, the value of the integer m is a relatively small value (e.g., a low single-digit value, i.e., m≦5). Also, with respect to the pitch of the shapes, a configuration is possible in which, letting Pp be a pitch that is larger than around 0.2 mm (i.e. Pp≧0.2 mm), shapes aligned with a pitch greater than or equal to Pp are provided on the upper face of the light guide plate 33, and shapes aligned at a pitch smaller than the pitch Pp are provided on the lower face of the light guide plate 33.

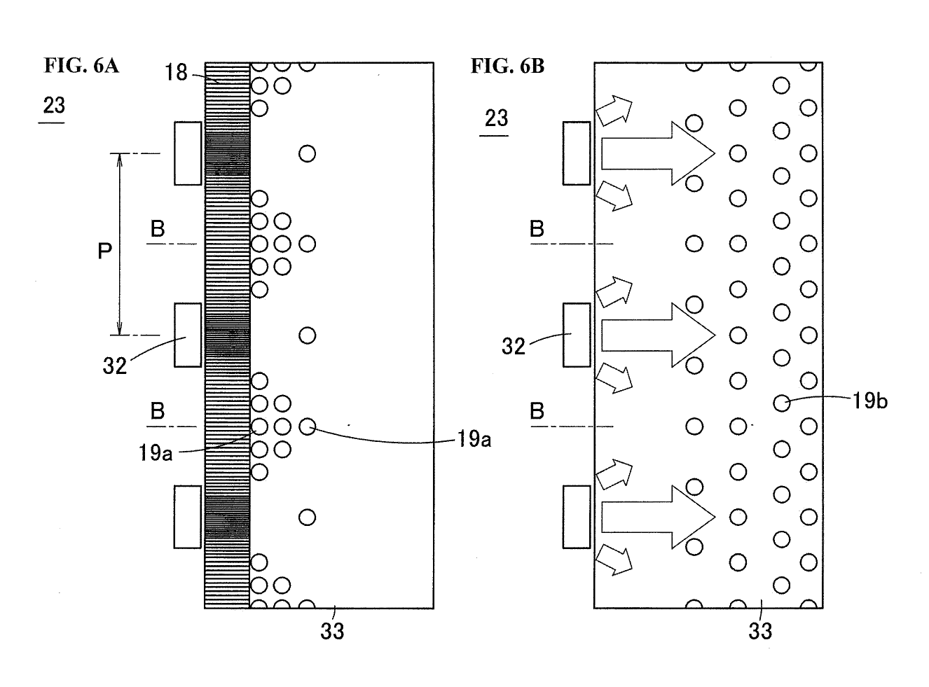

In the examples illustrated in FIGS. 4 and 5, only the first pattern 18 and the second pattern 19a that change at a pitch that is equal to the alignment pitch P of the light sources 32 are formed on the upper face of the light guide plate 33, and the third pattern 19b that changes at a pitch that is at one-half or less of the alignment pitch P of the light sources 32 (P/n: n≧2) is provided on the lower face of the light guide plate 33. In addition to this mode, as shown in FIG. 6 for example, a configuration is possible in which the first pattern 18 that changes at a pitch that is equal to the alignment pitch P of the light sources 32, and the second pattern 19a that is arranged at a pitch that is one-half or more of the alignment pitch P of the light sources 32 (i.e., a pitch corresponding to P or P/2) are formed on the upper face of the light guide plate 33, and the third pattern 19b that changes at a pitch that is at most one-third of the alignment pitch P of the light sources 32 (P/n: n≧3) is provided on the lower face of the light guide plate 33.

### Embodiment 1

Although only a portion corresponding to one light source 32 (one pitch-worth between the boundary lines B in FIGS. 4 and 5) will be described below, all of the planar light source apparatuses described hereinafter include multiple light sources 32 in line, and are used as the planar light source apparatuses 21 and 22.

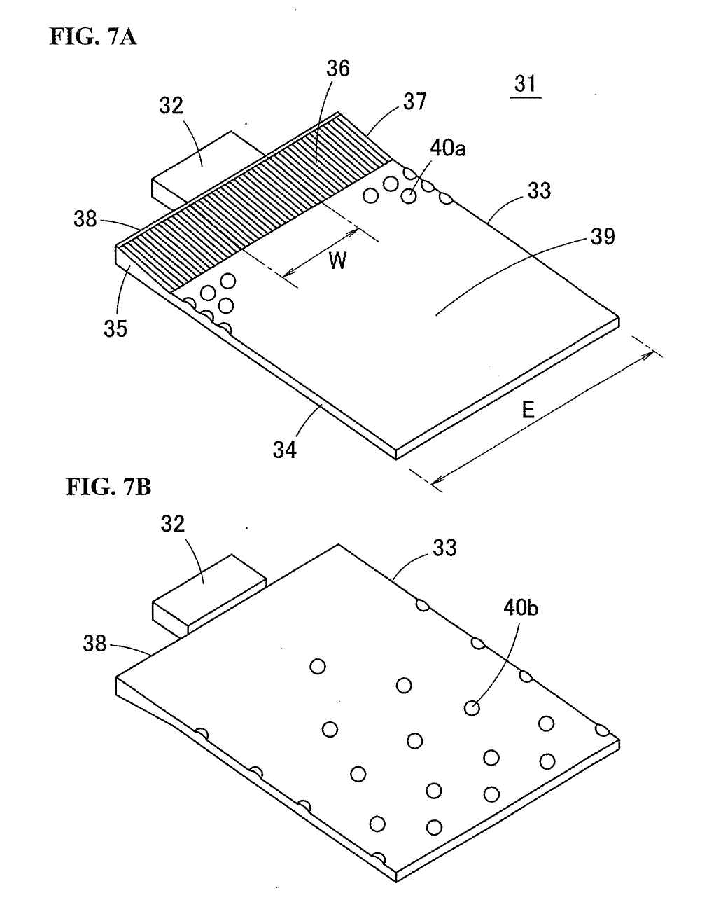

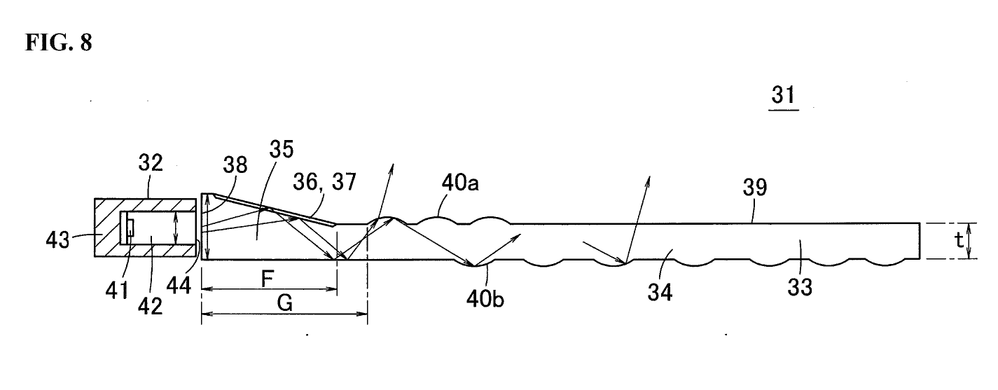

FIGS. 7A and 7B are perspective views showing an upper face and a lower face a planar light source apparatus 31 according to Embodiment 1 of the present invention. FIG. 8 is a schematic cross-sectional view taken in a direction perpendicular to a light receiving face 38 of the planar light source apparatus 31. Only a portion corresponding to one light source 32 (one pitch-worth between the boundary lines B in FIGS. 4A, 4B, 5A and 5B) in the planar light source apparatus 22 shown in FIGS. 5A and 5B is shown in the planar light source apparatus 31 shown in FIG. 7 (one portion of the original planar light source apparatuses 21 and 22).

The planar light source apparatus 31 is comprised of a light source 32 (point light source) and the light guide plate 33. The light source 32 has one or more LEDs built in and emits white light. As shown in FIG. 8, an LED 41 is sealed within transparent sealing resin 42, and the transparent sealing resin 42 is furthermore covered with white resin 43 with the exception of the front face, and the front face of the transparent sealing resin 42 that is exposed from the white resin 43 is a light emitting window 44 (light emitting face). The light source 32 is smaller than the width of the light guide plate 33, and is sometimes referred to as a point light source, whereas a cold cathode tube is referred to as a linear light source.

A light introduction portion 35 is provided at the end face of the thin plate-shaped light guide plate body 34 so as to be continuous with the light guide plate body 34 in the light guide plate 33. The light guide plate 33 is integrally molded using a transparent resin with a high refractive index, such as acrylic resin, polycarbonate resin (PC), cycloolefin-based materials, or polymethyl methacrylate (PMMA).

The light introduction portion 35 is a portion of the light guide plate 33 that is thick and approximately wedge-shaped, and the light source 32 is arranged so as to oppose a portion of a light receiving face 38, which is the end face of the light introduction portion 35. The thickness T of the end face of the light introduction portion 35 is greater than or equal to the height H of the light emission window 44, and for this reason, light emitted from the light source 32 effectively enters the light introduction portion 35 from the light receiving face 38 and the planar light source apparatus 31 has a high light usage efficiency.

An inclined face 37 is formed on the upper face of the light introduction portion 35 (on the same face as the light emission face 39 of the light guide plate body 34). The inclined face 37 is inclined as it extends from the thickest portion in the vicinity of the light receiving face 38 toward the end of the light guide plate body 34. The inclined face 37 extends in a belt shape from one side end to the other side end of the light guide plate 33.

As shown in FIG. 7, the first pattern 18, or in other words, a direction characteristic conversion pattern 36 is formed on the inclined face 37. The direction characteristic conversion pattern 36 includes multiple mountain-shaped and V-groove-shaped pattern elements aligned along the width direction of the light guide plate 33. That is to say, ridge lines and valley lines are alternatingly arranged in the direction characteristic conversion pattern 36. When the direction characteristic conversion pattern 36 is viewed from a direction that is perpendicular to the light emission face 39, the pattern elements, or in other words, the ridge lines and valley lines are arranged parallel to the direction perpendicular to the light receiving face 38 and are aligned parallel with each other along the width direction of the light guide plate 33. The pattern elements are left-right asymmetrical in the cross-section parallel to the light receiving face 38. Also, in the regions on the two sides of the light source center, at least one set of asymmetrical pattern elements having mutually different shapes exists. The direction characteristic conversion pattern 36 has a function of causing light that has entered the light introduction portion 35 to be reflected, whereby the direction characteristic spread in the light guide plate thickness direction for light that has entered the light introduction portion 35 is converted into a direction characteristic that is inclined toward a direction that is parallel to the surface direction of the light guide plate 33.

The light guide plate body 34 takes up a large portion of the area of the light guide plate 33, and as shown in FIG. 8, the thickness t is smaller than the maximum thickness T of the light introduction portion 35, and according to this, a decrease in the thickness of the light guide plate 33 can be achieved. The light guide plate body 34 has a planar shape in which the upper and lower faces are parallel, and the thickness of the light guide plate body 34 is approximately uniform.

The second pattern 19a, or in other words, the light emission portions 40a are provided on the upper face of the light guide plate body 34. The light emission portions 40a on the upper face may increase the intensity of emitted light in regions between light sources in which the light intensity is weak, and therefore, the light emission portions 40a are provided in regions that are between light sources and are relatively close to the light receiving face 38. Also, one group of light emitting portions 40a is aligned so as to repeat in the width direction at a pitch that is equal to the alignment pitch P of the light sources 32.

The third pattern 19b, or in other words, the light emitting portions 40b are included on the face opposite to the light emission face 39 (on the lower face) of the light guide plate body 34. The light emitting portions 40b that are provided on the lower face of the light guide plate body 34 are aligned in the direction perpendicular to the light receiving face 38 at an interval that gradually shortens as the distance from the light receiving face 38 increases. The light emitting portions 40b that are aligned parallel to the light receiving face 38 at a constant distance from the light receiving face 38 are aligned regularly at a pitch that is one-nth the alignment pitch P of the light source 32 (n being an integer greater than or equal to 2). Note that there are cases where the value of m is different according to the distance from the light receiving face 38 and there are cases where the value of m is the same. As a result, the overall number density of the light emitting portions 40b gradually increases as the distance from the light receiving face 38 increases.

In FIGS. 7 and 8, convex lens-shaped patterns are shown as the light emitting portions 40a and 40b, but prism-shaped patterns, cone-shaped patterns, or the like may be used. Also, patterns formed by sandblast processing or by photographically printing diffusion ink, diffraction grating patterns, arbitrary relief patterns, or the like may be used.

Thus, in the planar light source apparatus 31, as indicated by the arrows in FIG. 8, light that is emitted from the light source 32 enters the light introduction portion 35 from the light receiving face 38, is reflected by the upper face or the lower face of the light introduction portion 35, or passes through the light introduction portion 35 and is guided to the thin light guide plate body 34. Light that is introduced into the light guide plate body 34 is guided into the light guide plate body 34 while being reflected by the upper face and lower face of the light guide plate body 34, the light is reflected or diffused by the light emitting portions 40b, or is refracted or diffused by the light emitting portions 40a, and thereby is emitted approximately evenly from the light emission face 39.

Direction Characteristic Conversion Pattern According to Embodiment 1

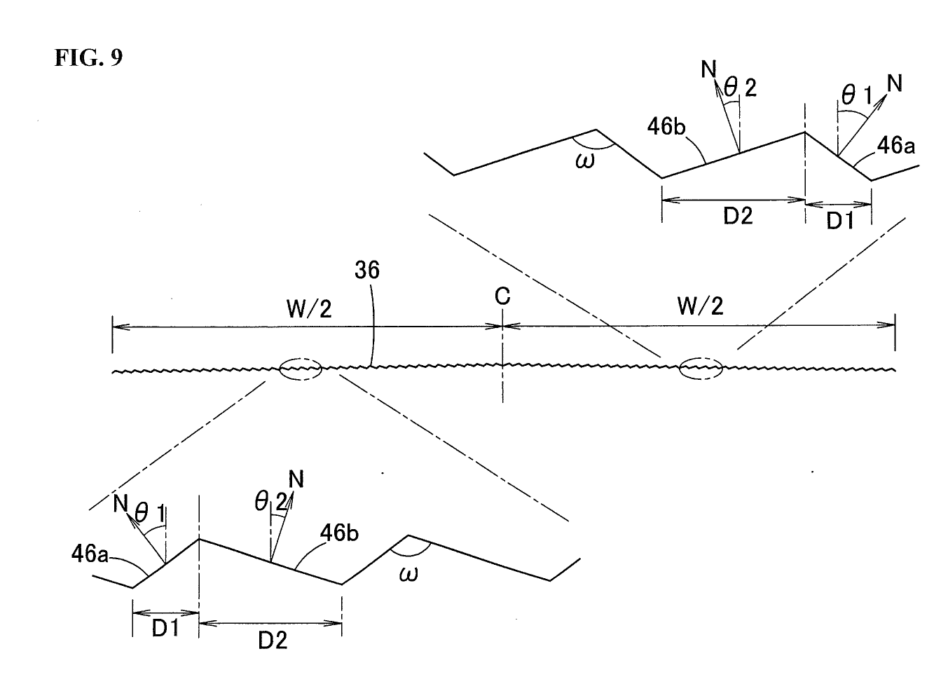

FIG. 9 shows a cross-section in the range of W in FIG. 7, of the direction characteristic conversion pattern 36 according to Embodiment 1. That is to say, FIG. 9 shows a portion of the cross-section of the direction characteristic conversion pattern 36 that has been cut parallel to the light receiving face 38. The portion shown in FIG. 9 is in a region located in front of the light source 32 and has a width that is equal to that of the light source 32 (light source width W) (i.e., a region whose width from the light source center C to the left and right sides is W/2). Here, the light source center C refers to a plane that passes through the light emission center 32a of the light source 32 and is perpendicular to the light receiving face 38 and the light emission face 39 of the light guide plate 33. Also, the light source width W does not refer to the package width of the light source 32, but instead refers to the width of the light emitting face (light emitting window 44). In FIG. 9, the direction characteristic conversion pattern 36 is left-right symmetrical with respect to the light source center C, but does not necessarily need to be left-right symmetrical.

In the planar light source apparatus according to Embodiment 1 of the present invention, the direction characteristic conversion pattern 36 has the structure or characteristic described below in regions of the light source width W in the cross-section that is parallel to the light receiving face 38. Regions outside of the light source width W may also have the same structure or characteristic as the region of the light source width W, but the supplied light power and light intensity are small in regions that are away from the light source 32, and therefore the structure of the direction characteristic conversion pattern 36 is not particularly limited on the outside of the light source width W.

In the region of the light source width W in the cross-section parallel to the light receiving face 38, a large portion or all of the pattern elements that constitute the direction characteristic conversion pattern 36 are asymmetrical in shape. That is to say, a pattern inclined face 46a that connects a ridge line (local maximum point in the cross-section) and one of the valley lines (local minimum point in the cross-section) adjacent to the ridge line, and a pattern inclined face 46b that connects the ridge line and the other valley line (local minimum in the cross-section) adjacent to the ridge line are left-right asymmetrical with respect to a straight line that passes through the ridge line and is perpendicular to the light emission face 39. Note that a portion of the pattern elements (e.g., the pattern elements at the position of the light source center C) may be left-right symmetrical. Here, the pattern inclined faces 46a and 46b are the upper face of the direction characteristic conversion pattern 36 that is located between adjacent ridge lines and valley lines. In the direction characteristic conversion pattern 36 shown in FIG. 9, the pattern inclined faces 46a and 46b are planar, but they may be curved or bent, as will be described later.

Also, in the W/2 region to the left of the light source center C (referred to below as the “left-side region of the light source center C”), when normal lines N are provided on the pattern inclined faces 46a and 46b from the inside of the light guide plate 33 toward the exterior, the sum of the horizontal widths D2 of the pattern inclined faces 46b in which the normal lines N are inclined toward the light source center (total value of the horizontal widths D2 of the pattern inclined faces 46b in the left-side region of width W/2) is larger than the sum of the horizontal widths D1 of the pattern inclined faces 46a in which the normal lines N are inclined toward the side opposite to the light source center (total value of the horizontal widths D1 of the pattern inclined faces 46a in the left-side region of width W/2) (condition 1: ΣD1<ΣD2).

Similarly, in the W/2 region to the right of the light source center C (referred to below as “the right-side region of the light source center C”), when normal lines N are provided on the pattern inclined faces 46a and 46b from the inside of the light guide plate 33 toward the exterior, the sum of the horizontal widths D2 of the pattern inclined faces 46b in which the normal lines N are inclined toward the light source center (total value of the horizontal widths D2 of the pattern inclined faces 46b in the right-side region of width W/2) is larger than the sum of the horizontal widths D1 of the pattern inclined faces 46a in which the normal lines N are inclined toward the side opposite to the light source center (total value of the horizontal widths D1 of the pattern inclined faces 46a in the right-side region of width W/2) (condition 1: ΣD1<ΣD2).

In order to realize this type of mode, with two adjacent pattern inclined faces 46a and 46b (pattern elements), it is sufficient that the horizontal width D2 of the pattern inclined face 46b in which the normal line N is inclined toward the light source center is larger than or partially the same as the horizontal width D1 of the pattern inclined face 46a in which the normal line N is inclined toward the side opposite to the light source center (condition 2: D1<D2). It is sufficient that at least a portion of the pattern elements in the region of the light source width W satisfy condition 2. According to one or more embodiments of the present invention, as many pattern elements as possible fulfills condition 2, but it is not necessarily required of all of the pattern elements.

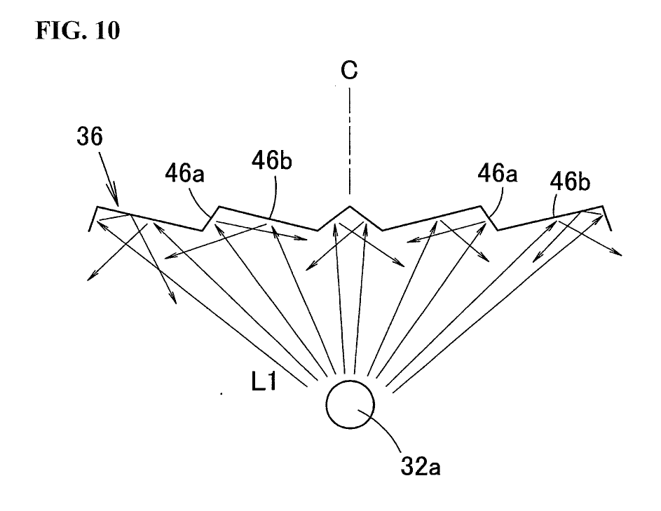

In the planar light source apparatus 31 of Embodiment 1, the sum of the horizontal widths D2 of the pattern inclined faces 46b in which the normal line N is inclined toward the light source center is greater than the sum of the horizontal widths D1 of the pattern inclined faces 46a in which the normal line N is inclined toward the side opposite to the light source center in each of the regions to the left and right of the light source center C (condition 1). In particular, in many of the pattern elements, the horizontal width D2 of the pattern inclined face 46b in which the normal line N is inclined toward the light source center is larger than or partially the same as the horizontal width D1 of the pattern inclined face 46a in which the normal line N is inclined toward the side opposite to the light source center (condition 2). As shown in FIG. 10, light L1 that is emitted from a light emission center 32a toward an oblique direction is incident on the pattern inclined face 46a at an angle that is close to being perpendicular thereto. As a result of the above-mentioned conditions being fulfilled, the area of the pattern inclined face 46a on which the light L1 is incident is smaller and light is less likely to leak from the pattern inclined face 46a compared to the case where the pattern elements of the direction characteristic conversion pattern are left-right symmetrical. Furthermore, since the inclination angle of the pattern inclined face 46a in which the normal line N is inclined toward the side opposite to the light source center C is larger, the incident angle of the light L1 that is incident on the pattern inclined face 46a is larger compared to the case where the pattern elements of the direction characteristic conversion pattern are left-right symmetrical, and thus the light L1 is less likely to leak from the pattern inclined face 46a. As a result, according to the planar light source apparatus 31 of Embodiment 1, it is possible to suppress light leakage from the inclined face 37 and thus the light usage efficiency increases.

Since the direction characteristic conversion pattern 36 that is provided on the upper face of the light guide plate 33 has the above-described structure, the direction characteristic conversion pattern 36 is aligned with a pitch that is equal to the alignment pitch P of the light sources 32 in the case where the light guide plate 33 is formed continuously such that the light sources 32 can be arranged as in the planar light source apparatuses 21 and 22 shown in FIGS. 4 and 5. Accordingly, shapes with a pitch equal to the alignment pitch P of the light sources 32, that is to say, the direction characteristic conversion pattern 36 and the light emission portions 40a are provided on the upper face of the light guide plate 33, and the light emission portions 40b are aligned on the lower face of the light guide plate 33 with a pitch that is smaller than the alignment pitch P of the light sources 32, or in other words, at a pitch corresponding to P/n (n≧2). As a result, if the light sources 32 are arranged so as to match the patterns on the upper face, it is possible to suppress light leakage from the inclined face 37 and luminance unevenness in the light emission portion 40b even if the patterns on the upper face and the lower face become misaligned in the width direction at the time of transfer molding.

FIGS. 11A and 11B are a top view and a bottom view of the planar light source apparatus shown in FIG. 2. FIGS. 11C and 11D are a top view and a bottom view of the planar light source apparatus according to Embodiment 1 of the present invention. In FIGS. 11A and 11B, the distribution of the second shapes 19 is obtained by simulation. In FIGS. 11C and 11D, the distribution of the light emitting portions 40a and 40b is obtained by simulation. These figures are approximate to the actual pattern arrangement, and features of the present invention become clear when focus is placed on the regions in the vicinity of the light sources 13 and 32 for the second shapes 19 and the light emitting portions 40a and 40b.

Note that the direction characteristic conversion pattern 36 is not limited to having. V-grooves that are constituted by flat planar surfaces, and may be constituted by curved or bent surfaces. Also, in the planar light source apparatuses 21 and 22 as shown in FIGS. 4 and 5 in which multiple light guide plates 33 are connected, the arrangement of the direction characteristic conversion pattern 36 and the light emission portions 40a and 40b at the end of the light guide plate 33 may become misaligned from the above-described regular arrangement.

Case where pattern elements change according to distance from the light source center

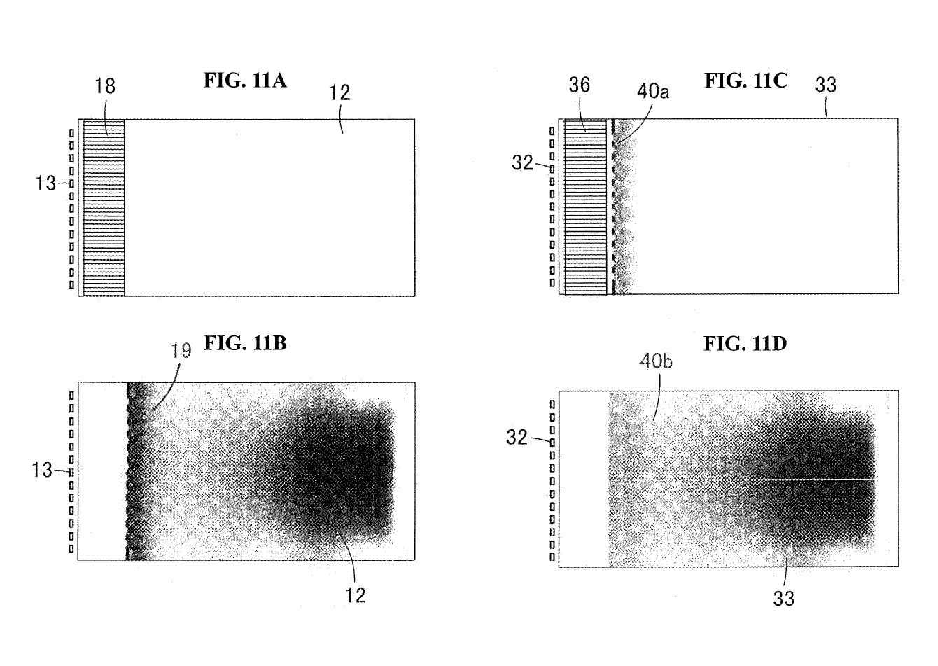

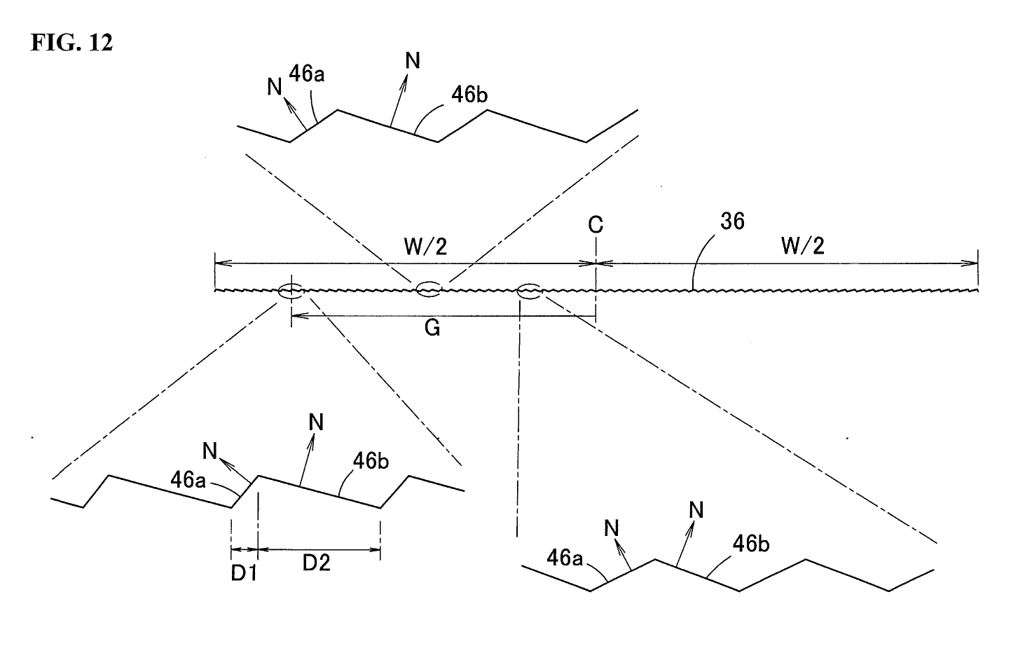

With the direction characteristic conversion pattern 36 shown in FIG. 9, pattern elements that have same cross-sectional shape are aligned repeatedly in a region to the right and a region to the left of the light source center C, but it is possible for the cross-sectional shapes of the pattern elements to change according to the distance from the light source center C. FIG. 12 shows a direction characteristic conversion pattern 36 in which the cross-sectional shapes of the pattern elements change according to a distance G from the light source center C. In particular, with the direction characteristic conversion pattern 36 shown in FIG. 12, the ratio of the horizontal width D1 of the pattern inclined face 46a in which the normal line N is inclined toward the side opposite to the light source center C, with respect to the sum of the horizontal widths of the adjacent pattern inclined faces 46a and 46b (D1+D2), or in other words, D1/(D1+D2) decreases as the distance G from the light source center C increases or is partially the same.

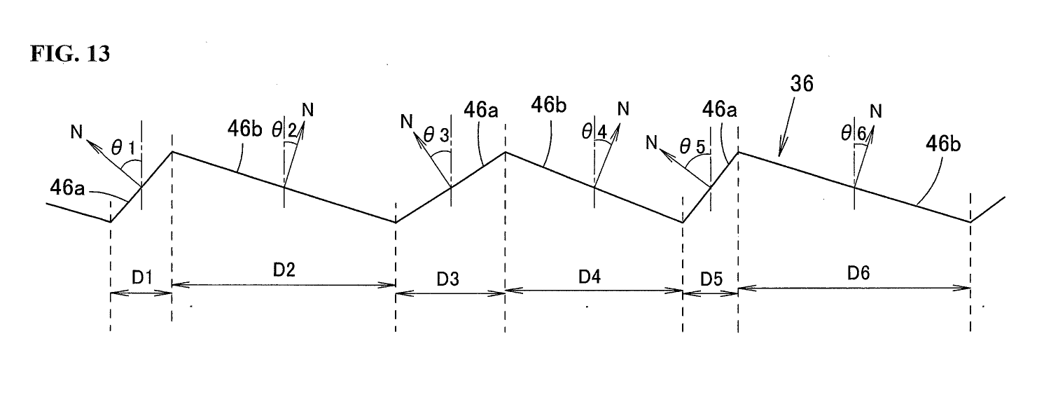

In the case where the cross-sectional shapes of the pattern elements gradually change in this way as well, letting the horizontal widths of the pattern inclined faces 46a and 46b be D1, D2, D3, D4, . . . , as shown in FIG. 13, it is sufficient that in the left-side region and the right-side region, condition 1 for the sum of the horizontal widths of the pattern inclined faces is satisfied, or in other words:

D1+D3+D5+ . . . <D2+D4+D6+ . . .

In order to achieve this, it is sufficient that a large portion of the pattern elements in the left-side region and the right-side region satisfy condition 2, or in other words:

D1<D2, D3<D4, D5<D6, . . .

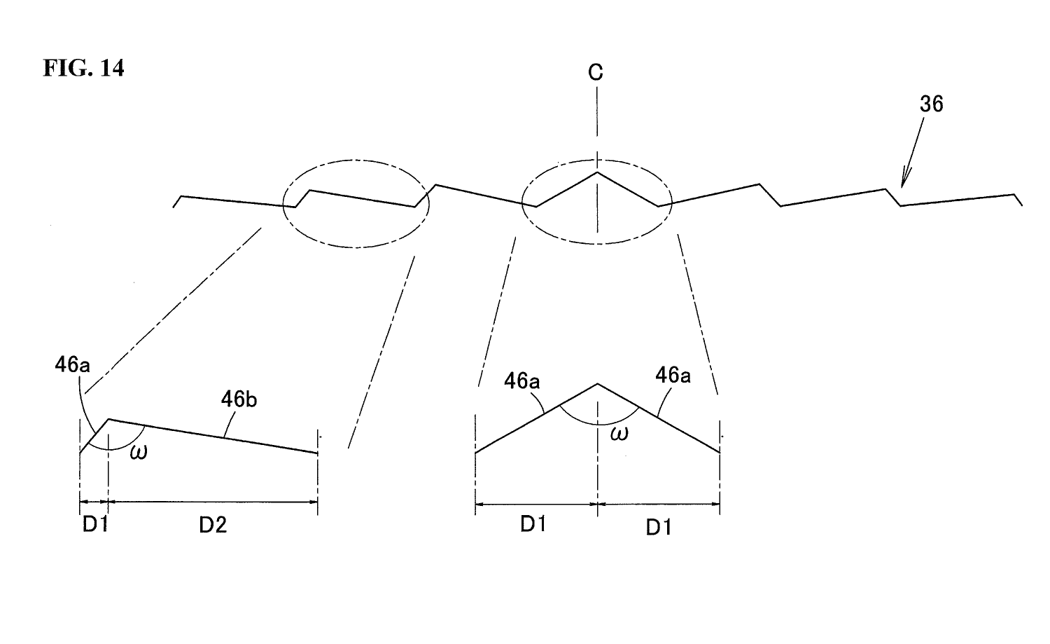

In the case where the cross-sectional shapes of the pattern elements change according to the distance G from the light source center C as described above, according to one or more embodiments of the present invention, they change such that, as shown in FIG. 14, the ratio D1/(D1+D2) of the pattern inclined face 46a decreases as the distance G from the light source center C increases or is partially the same, while the apex angle ω between the adjacent pattern inclined faces 46a and 46b is kept constant.

There are various modes of changing the cross-sectional shapes of the pattern elements in accordance with the distance G from the light source center C. For example, the apex angle ω of the pattern elements may gradually decrease as the distance from the light source center C increases. Also, the apex angle ω of the pattern elements may gradually increase as the distance from the light source center C increases. Also, in a direction characteristic conversion pattern 36 in which pattern elements having curved faces are aligned, the extent of curvature in the pattern elements may gradually change as the distance from the light source center C increases.

Range between light sources in which light emitting portions are provided

Letting P be the arrangement pitch of the light sources 32 and n be the refractive index of the light guide plate 33, according to one or more embodiments of the present invention, the light emitting portions 40a are provided that are to be provided between light sources with the period of the light sources 32, within a distance of

3×P×√(n²−1)

from the light receiving face 38. Light emitted from the light source 32 enters the light guide plate 33 from the light receiving face 38 and is guided into the light guide plate 33. In a view from a direction perpendicular to the upper face of the light guide plate 33, the light spreads toward both sides at an angle θ. Here, letting θ be the critical angle of total reflection and n be the refractive index of the light guide plate 33, the relationship is represented as:

θ=Arcsin(1/n)

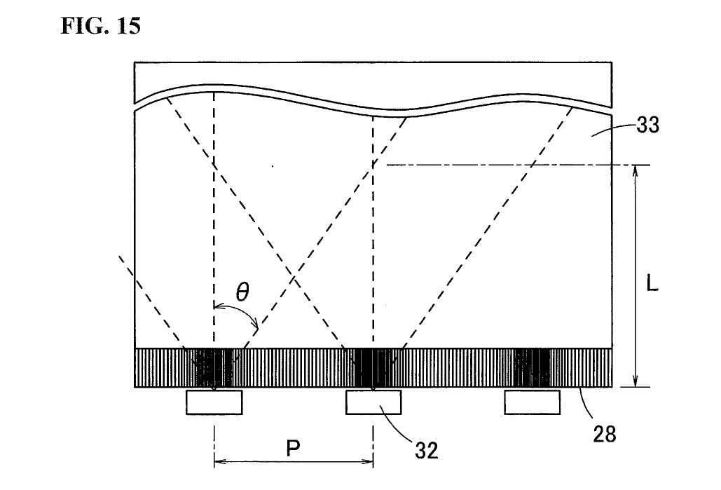

As shown in FIG. 15, when multiple light sources 32 are aligned at the alignment pitch P, a region reached by light from only one of the light sources 32 exists in the region extending from the light receiving face 38 to L in the figure (light from both light sources reaches regions that are farther than L). For this reason, luminance unevenness tends to occur in the region extending up to L.

As can be understood from FIG. 15, the distance is:

L=P/tan θ=P/tan [Arcsin(1/n)]=P×√(n²−1)

Here, the above-described equation representing the critical angle θ was used. Accordingly, in order to prevent luminance from decreasing between the light sources 32, light emitting portions 40a need to be provided in the regions between the light sources 32 at a distance from at least the light receiving face 38 to L. However, in actuality, L is not sufficient as the distance at which to provide the light emitting portions 40a, and a sufficient effect of preventing luminance unevenness cannot be obtained. Let Smax be the maximum value and 5 min be the minimum value for the light intensity measured along the direction parallel to the light receiving face 38. Based on experiments and experience, according to one or more embodiments of the present invention, the ratio Smax/Smin is 1.02 or lower in order to reduce the noticeability of luminance unevenness. For this reason, it is sufficient that the light emitting portions 40a are at a distance of

3×L=3×P×√(n²−1)

from the light receiving face 38 (the light emitting portions 40a are not needed in the area past 3×L). To be sure, change in light intensity is low in the areas that are located farther than 2×L from the light receiving face 38, and therefore, in reality, it is acceptable to provide the light emitting portions 40a only in the regions extending from the light receiving face 38 to 2×L between the light sources 32.

### Modified Example of Embodiment 1

FIGS. 16A and 16B are a perspective view from above and a perspective view from below showing the planar light source apparatus according to a modified example of Embodiment 1 of the present invention. In this modified example, the light emitting portions 40b (third pattern) that are to be a base pattern are formed on the lower face of the light guide plate 33. Also, in addition to the direction characteristic conversion pattern 36 (first pattern) and the light emitting portions 40a (second pattern), oriented shapes 40c (fifth shapes) are need on the upper face of the light guide plate 33. A base pattern is a pattern that is used in common regardless of the alignment pitch P of the light sources 32, for example. The base pattern is aligned in the width direction at a pitch that is smaller than the normal alignment pitch P (the pitch may vary according to the distance from the light receiving face 38). The light emitting portions 40a are shapes for preventing the luminance from decreasing and becoming dark between the light sources. They are aligned so as to repeat in the width direction at a pitch that is equal to the alignment pitch P of the light sources 32. The oriented shapes 40c are shapes that are aligned regularly along the width direction at a pitch that is smaller than the alignment pitch P of the light sources 32. Adjusting the pitch and the density of the oriented shapes 40c as necessary according to the arrangement of the light sources 32 makes the luminance of the light emission face 39 uniform. By adding these kinds of oriented shapes 40c, it is possible to reduce luminance unevenness in the planar light source apparatus and significantly increase the uniformity of the luminance distribution. Note that the oriented shapes 40c (fifth shapes) may be formed at random pitches.

FIG. 17 is a perspective view showing the planar light source apparatus according to another modified example of Embodiment 1 of the present invention. In this modified example, multiple lenticular lenses 48 (fifth shapes) that extend in the direction perpendicular to the light receiving face 38 are provided on the light emission face 39. If the lenticular lenses 48 are provided on the light emission face 39, the light emitted from the light emission face 39 can be spread in the width direction of the light guide plate 33.

Note that the light emission face 39 may be a specular surface, and it may be a rough surface so as to diffuse the emitted light.

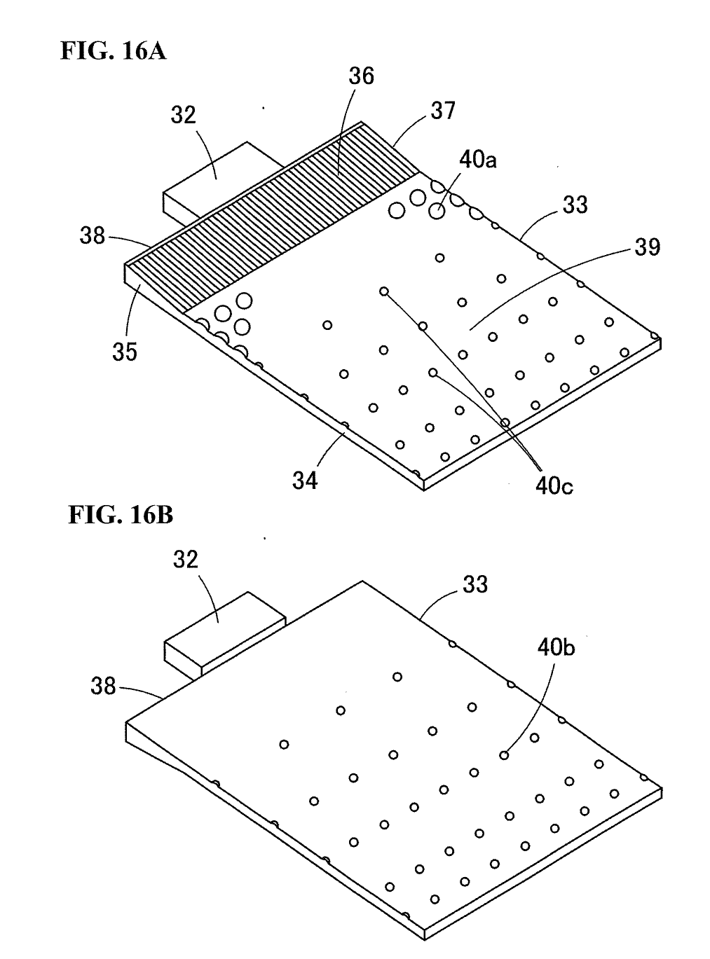

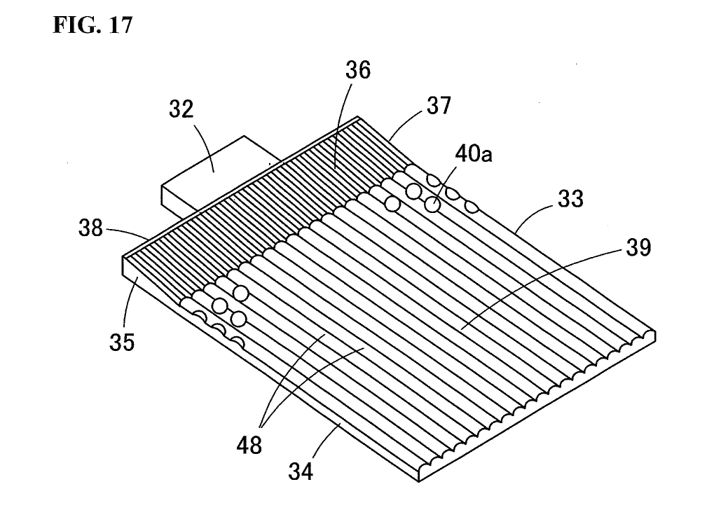

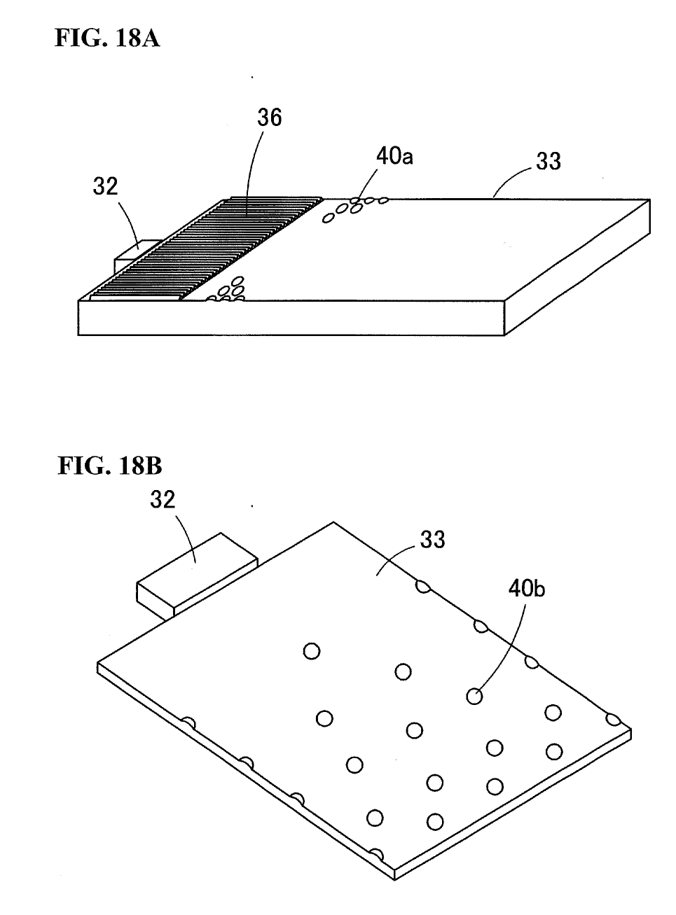

FIGS. 18A and 18B are a perspective view from above and a perspective view from below showing the planar light source apparatus according to yet another modified example of Embodiment 1 of the present invention. In this modified example, a planar light guide plate 33 is used, the direction characteristic conversion pattern 36 is provided on the end region of the light source side of the light guide plate 33, and the light emitting portions 40a are provided in the vicinity of the direction characteristic conversion pattern 36. Also, the light emitting portions 40b are provided on the lower face of the light guide plate 33.

FIGS. 19A and 19B are a perspective view from above and a perspective view from below showing the planar light source apparatus according to yet another modified example of Embodiment 1 of the present invention. In this modified example, the light emission portions 40b, which are aligned in the width direction with a pitch that is smaller than the alignment pitch P of the light sources 32, are formed on the upper face of the light guide plate 33 on which the inclined face 37 and the light emission face 39 are provided. Also, the direction characteristic conversion pattern 36 and the light emitting portions 40a, which repeat at the same pitch as the alignment pitch P of the light sources 32, are formed on the lower face of the light guide plate 33.

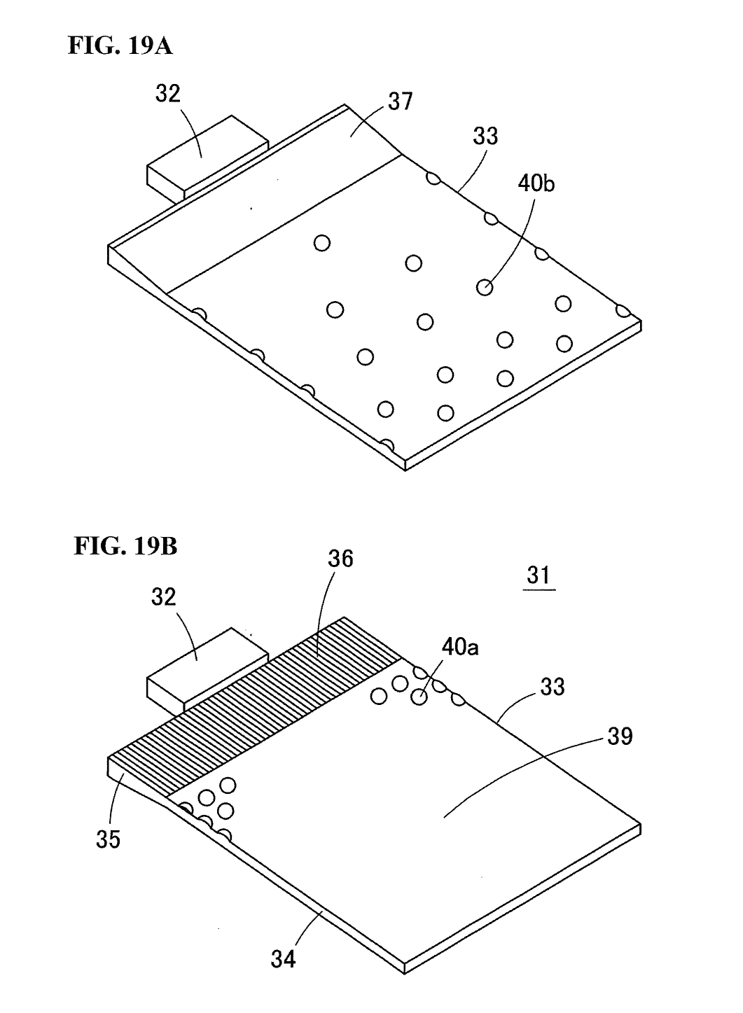

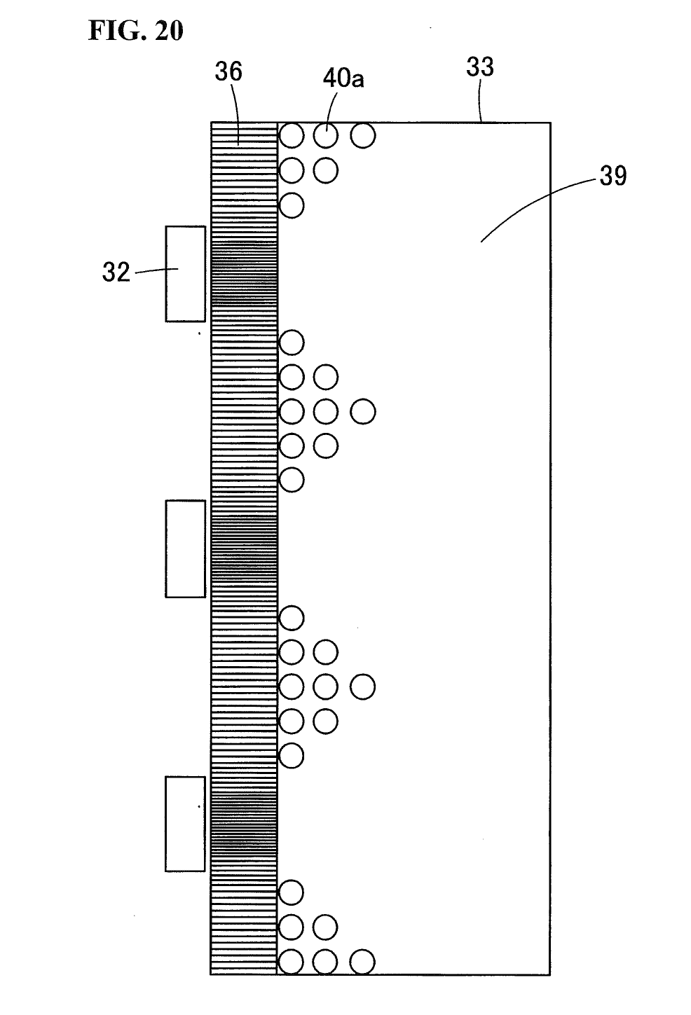

FIG. 20 is a top view of the planar light source apparatus according to yet another modified example of Embodiment 1 of the present invention. FIG. 20 shows a planar light source apparatus in which multiple light sources 32 are arranged, similarly to that of FIG. 5. The planar light source apparatus in FIG. 20 differs from the planar light source apparatus in FIG. 5 in that the side ends of the light guide plate 33 have been extended outward past the halfway point between the light sources 32 (boundary line B) of the light guide plate 33. At the side ends of the light guide plate 33, there is no light that is incident from a neighboring light source 32, and therefore the side end portions of the light guide plate 33 tend to be darker. For this reason, the side end portions of the light guide plate 33 are extended and the light emission portions 40a are provided thereon, and the side end portions of the light guide plate 33 are thus prevented from becoming darker.

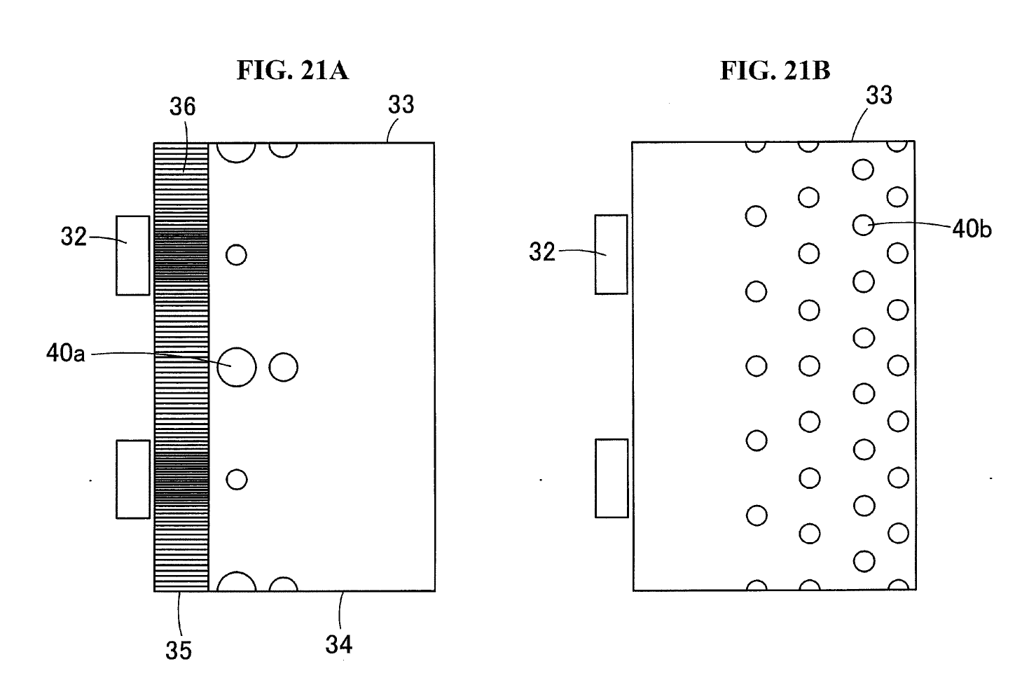

FIGS. 21A and 21B are a top view and a bottom view of the planar light source apparatus according to yet another modified example of Embodiment 1 of the present invention. With the planar light source apparatus 31 of Embodiment 1, the shape and size of the light emitting portions 40a are constant, and the intensity of light emitted from the light emission face 39 is adjusted by adjusting the density of the light emitting portions 40a. In contrast to this, in the modified example shown in FIGS. 21A and 21B, adjustment is performed using the size and area of the light emitting portions 40a, or using the depth and curvature of the light emitting portions 40a.

Also, a pattern (fourth pattern) having no periodicity may be provided on the lower face of the light guide plate 33 in addition to or in place of the periodic light emitting portions 40b, although this is not illustrated in the figure.

Note that the above-described modified examples of Embodiment 1 are applied to Embodiment 2 and subsequent embodiments below as well. It is also possible to combine the modified examples.

### Embodiment 2

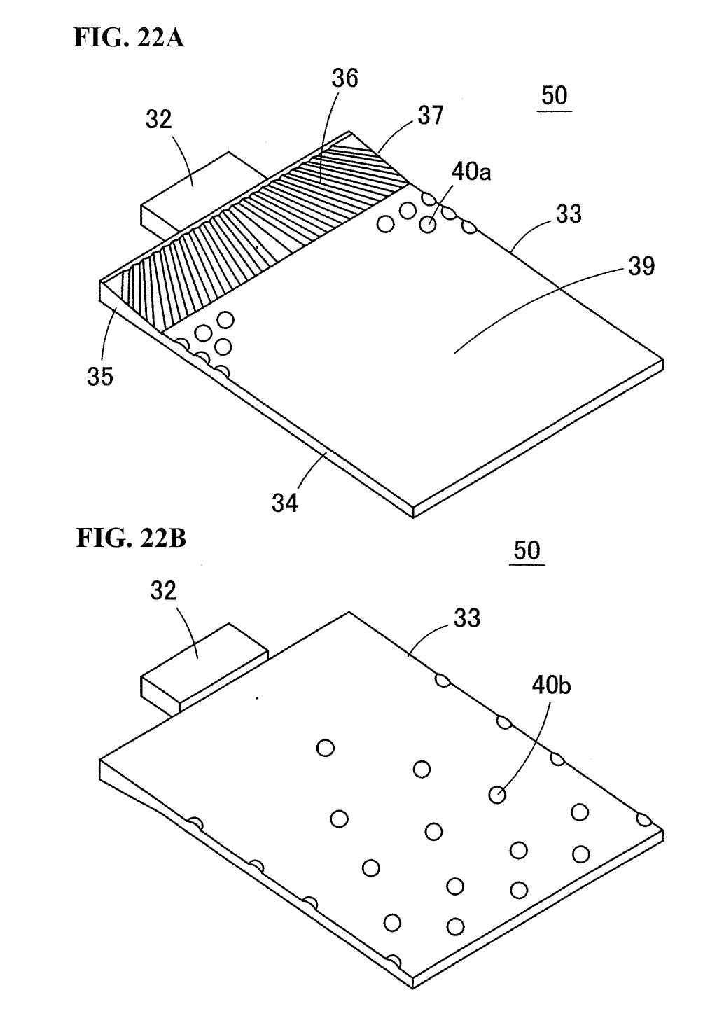

FIGS. 22A and 22B are a perspective view from the upper face side and a perspective view from the lower face side showing a planar light source apparatus 50 according to Embodiment 2 of the present invention. With the planar light source apparatus 50, the direction characteristic conversion pattern 36 is provided in a radial shape on the inclined face 37. Other configurations are the same as those of Embodiment 1, and therefore constituent elements that are the same as those of Embodiment 1 are denoted by the same reference numerals, and the description thereof will not be repeated (the same follows for embodiments below).

In the present embodiment, the direction of the direction characteristic conversion pattern 36 is approximately parallel with the radiation direction of the light from the light source 32 in a view from a direction perpendicular to the upper face of the light guide plate 33, and therefore the effect of preventing light leakage from the inclined face 37 when using a point light source is further improved.

### Embodiment 3

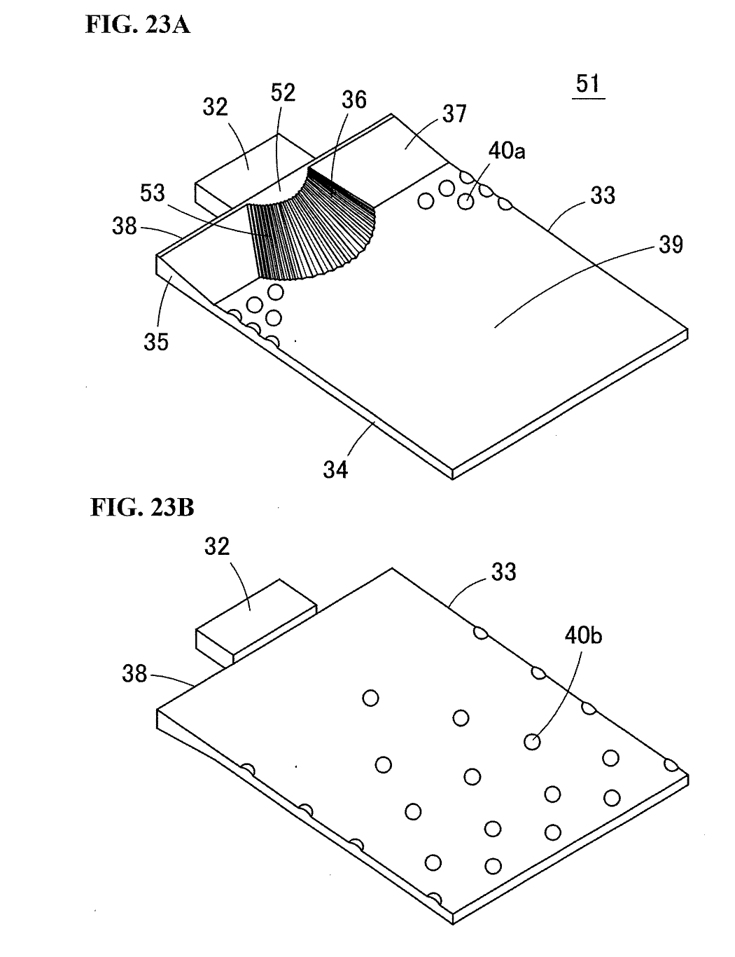

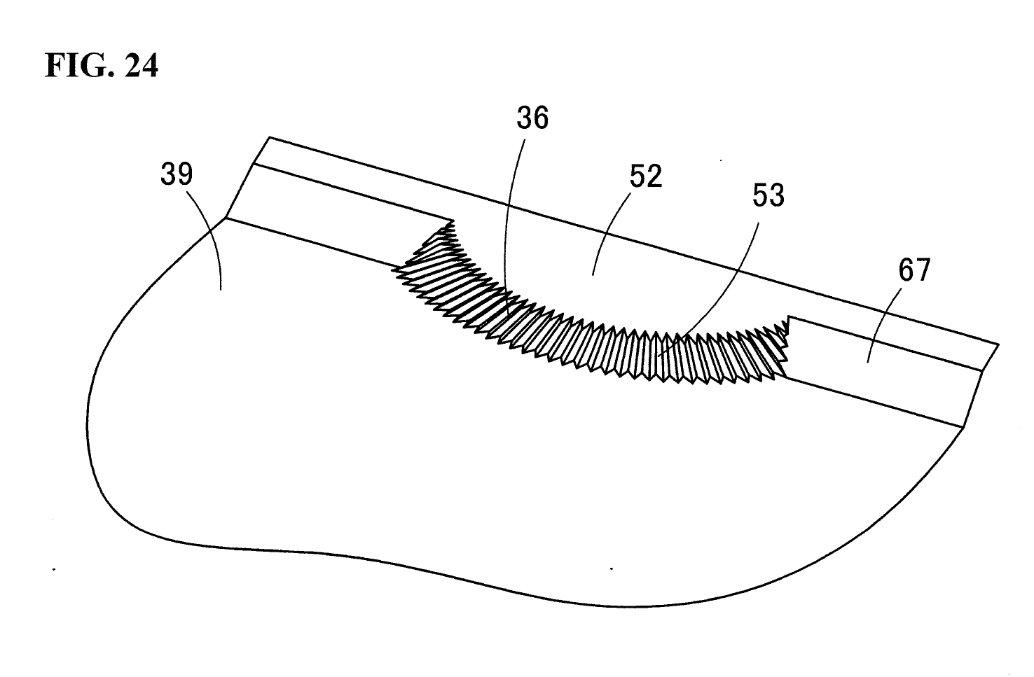

FIGS. 23A and 23B are a perspective view from the upper face side and a perspective view from the lower face side showing a planar light source apparatus 51 according to Embodiment 3 of the present invention. With the planar light source apparatus 51 of Embodiment 3, a protruding portion 52 having a shape that is approximately half of a conical trapezoid protrudes on the upper face of the light introduction portion 35 so as to be overlaid on the inclined face 37. As shown in FIG. 24, the outer circumferential face of the protruding portion 52 is an inclined face 53 that is inclined extending from the upper face of the protruding portion 52 to the light emission face 39 of the light guide plate body 34, and multiple direction characteristic conversion patterns 36 having a V-groove structure are formed on the inclined face 53. In a view from a direction perpendicular to the light emission face 39, the direction characteristic conversion pattern 36 is a belt-shaped region with an arc shape, and the direction characteristic conversion patterns 36 that have the same V-groove shape are aligned radially therein. When the apex angle of the peak portion in a view from the ridge line direction of the direction characteristic conversion patterns 36 that have the V-groove structure (maximum setting angle forming a plane that constitutes a V-groove structure) is 120 degrees, the effect of preventing light leakage from the inclined face 37 is optimized. In this embodiment, the protruding portion 52 and the direction characteristic conversion pattern 36, or the protruding portion 52 on which the direction characteristic conversion pattern 36 is formed is the first pattern 18.

According to the three-dimensional direction characteristic conversion pattern 36 as of the present embodiment, the effect of preventing light leakage from the inclined face 37 is greater, and in the case of aligning the light sources 32 at a constant pitch, the direction characteristic conversion pattern 36 is also formed at a pitch that is the same as the alignment pitch P of the light sources 32. Accordingly, the light emitting portions 40a that are arranged between the light sources are formed on the face on the same side as the direction characteristic conversion pattern 36, and the light emitting portions 40b are formed on the face on the side opposite to the direction characteristic conversion pattern 36.

### Modified Example of Embodiment 3

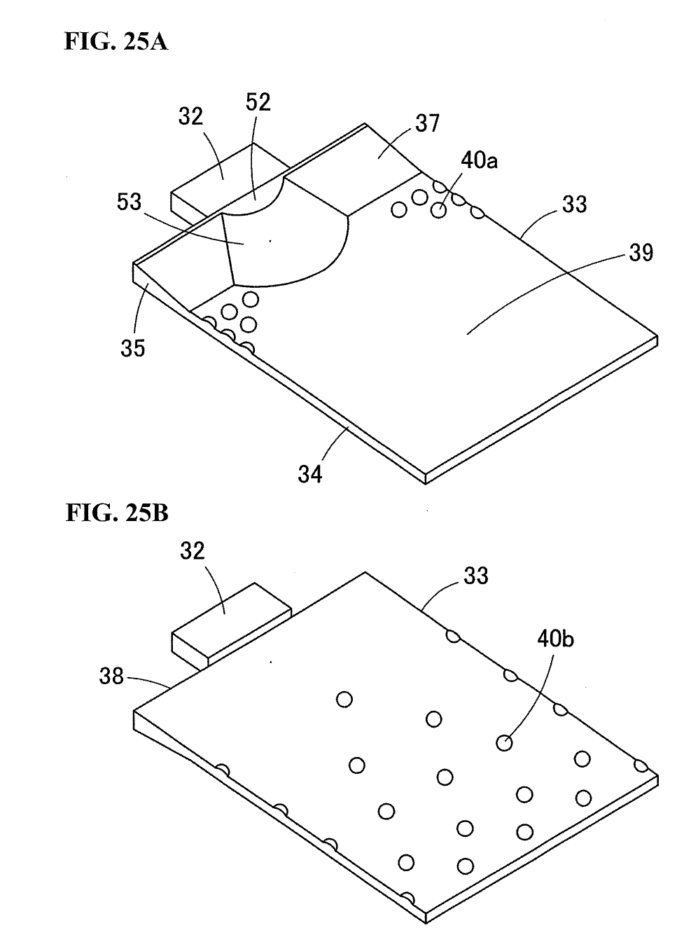

FIG. 25 is a perspective view showing a modified example of Embodiment 3 of the present invention. In this modified example, only the protruding portion 52 is provided at the central portion of the inclined face 37. The direction characteristic conversion pattern 36 is not provided on the outer circumferential face of the protruding portion 52, and in this case, the protruding portion 52 is the first pattern 18.

### Embodiment 4

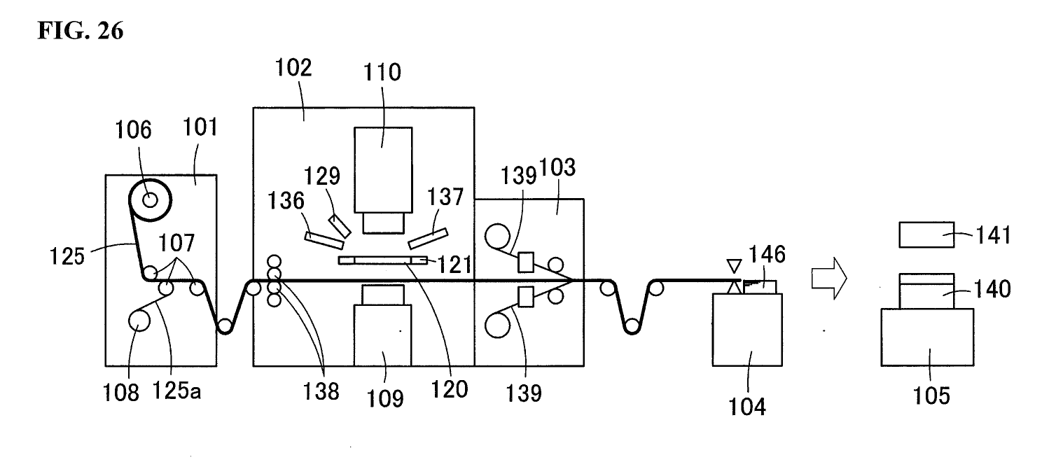

A light guide plate forming apparatus for molding a light guide plate such as that described above will be described next. FIG. 26 is a schematic diagram of the light guide plate forming apparatus. The light guide plate forming apparatus includes a material supply apparatus 101, a transfer molding apparatus 102, a film adhesion apparatus 103, a cutting apparatus 104, and an external shape processing apparatus 105.

The material supply apparatus 101 unrolls a resin sheet 125 that is rolled around a main roller 106 and supplies the resin sheet 125 to the transfer molding apparatus 102. Multiple rollers 107 are arranged at an intermediate position, and immediately after the second roller 107, a protective sheet 125a adhered to the resin sheet 125 is peeled off and rolled up by a roll-up roller 108. Here, polycarbonate (melting point=approximately 240° C., glass-transition temperature=approximately 150° C.) is used for the resin sheet 125.

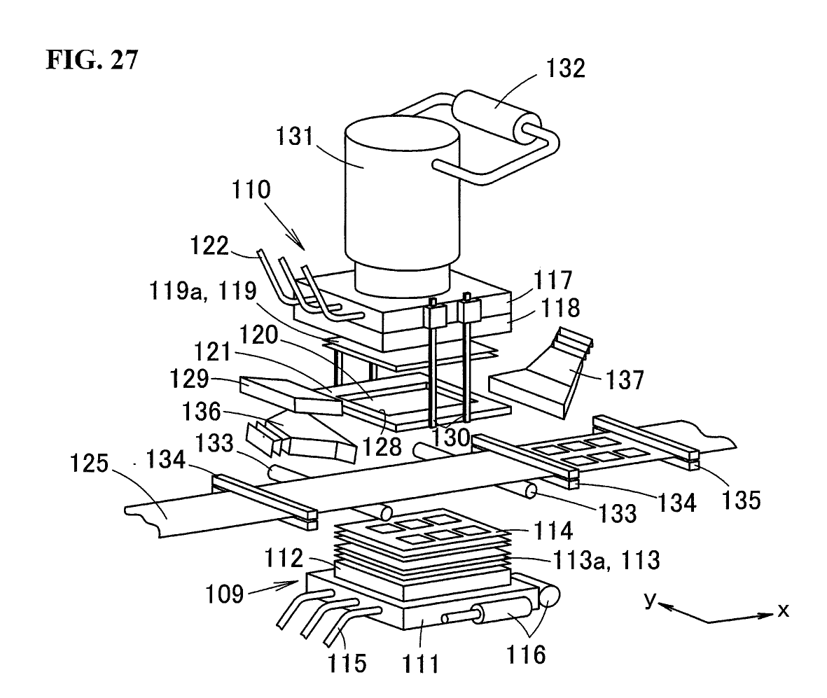

As shown in FIG. 27, the transfer molding apparatus 102 includes a lower mold 109 and an upper mold 110. The lower mold 109 is configured by a lower mold intermediate plate 112, a lower mold insulation plate 113, and a lower mold transfer plate 114 (second metallic mold) arranged in the stated order on the upper face of a lower mold support plate 111.

The lower mold support plate 111 is formed by forming stainless steel (SUS) into a shape that is rectangular in a plan view. Multiple through-holes are formed between the two side faces of the lower mold support plate 111, and a heater 115 and a thermocouple (not shown) are inserted therein. The lower mold support plate 111 is heated due to the heater 115 being energized, and it is thus possible to raise the temperature of the lower mold transfer plate 114 via the lower mold intermediate plate 112 and the lower mold thermal insulation plate 113. Here, the heating temperature of the lower mold support plate 111 achieved by energizing the heater 115 is suppressed to about 180° C.

The lower mold intermediate plate 112 is formed by forming stainless steel (SUS) into a shape that is rectangular in a plan view, similarly to the lower mold support plate 111.

The lower mold thermal insulation plate 113 is an integrated body of multiple layers of thermal insulation sheets 113a that are made of a resin material such as polyimide (shown in FIG. 27 in a state of being decomposed in the up-down direction). The thermal insulation performance can be adjusted by changing the number of stacked thermal insulation sheets. Here, due to the lower mold thermal insulation plate 113 being constituted by five thermal insulation sheets, the heating temperature of the lower mold support plate 111 is about 180° C., whereas the temperature on the lower mold transfer plate 114 is about 150° C. This makes it possible to prevent the resin sheet 125 from deforming due to the influence of heat from the lower mold support plate 111. Accordingly, the transfer molding apparatus 102 can be made smaller since the conveyance line of the resin sheet 125 can be brought closer to the lower mold 109 and the distance at the time of release from the mold does not need to be increased. Also, the lower mold thermal insulation plate 113 also plays a role of preventing the heat from the upper mold 110 from escaping to the lower mold when the mold is closed and the resin sheet 125 is heated. Furthermore, the lower mold thermal insulation plate 113 also plays a role of preventing the lower mold support plate 111 from being cooled when the resin sheet 125 is cooled.

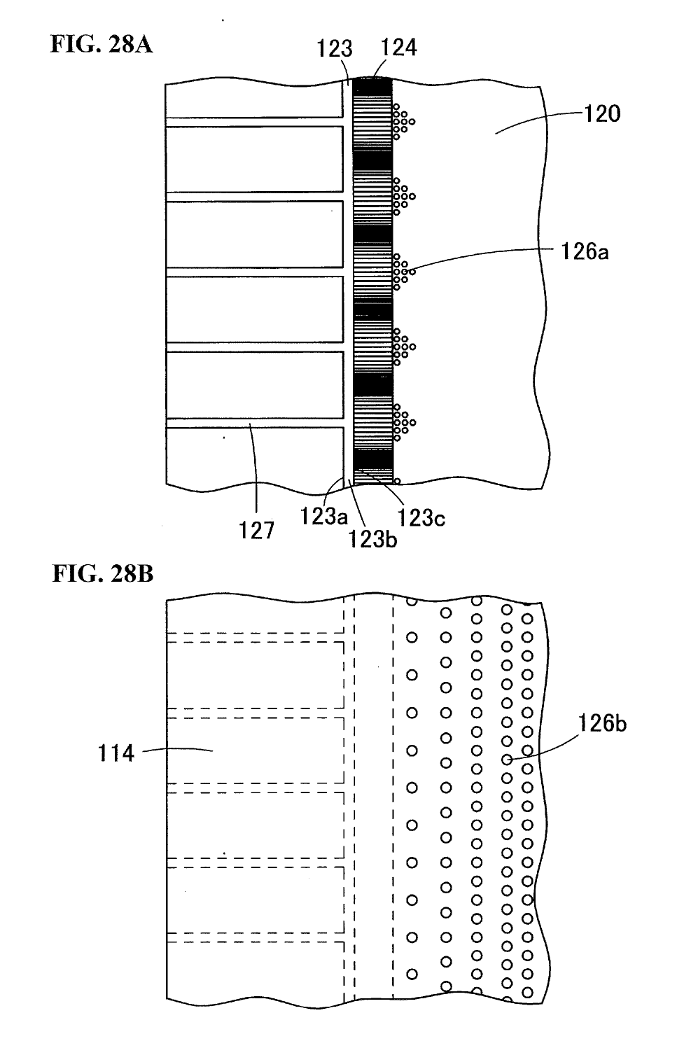

The lower mold transfer plate 114 is formed by forming nickel-chrome alloy into a shape that is rectangular in a plan view. A transfer face having multiple semi-spherical depressions 126b with a depth in the order of less than a micron (third pattern of mold), or in other words, depressions for molding the light emitting portions 40b is formed on the upper face of the lower mold transfer plate 114 as shown in FIG. 28B. This makes it possible to mold the multiple hemispherical light emitting portions 40b on the lower face of the resin sheet 125 that is the transfer destination.

The lower mold 109 can move in a horizontal plane in the x axis direction and in the y axis direction using a driving means such as a servo motor (not shown). Also, the amount of motion is detected by a micrometer 116 and the position in the x axis direction and the y axis direction in the horizontal plane can be finely adjusted based on the detection result. Note that the lower mold may be moved manually.

The upper mold 110 is configured by an upper mold intermediate plate 118, an upper mold thermal insulation plate 119, and a holding plate 121 that holds an upper mold transfer plate 120, arranged in the stated order on the lower face of an upper mold support plate 117.

The upper mold support plate 117 is formed by forming stainless steel (SUS) into a shape that is rectangular in a plan view, similarly to the lower mold support plate 111. Multiple through-holes are formed between the two side faces of the upper mold support plate 117, and a heater 122 and a thermocouple (not shown) are inserted therein. Due to the heater 122 being energized, it is possible to raise the temperature of the upper mold support plate 117 to about 280° C.

The upper mold intermediate plate 118 is formed by forming stainless steel (SUS) into a plate shape that is rectangular in a plan view, similarly to the upper mold support plate 117.

The upper mold thermal insulation plate 119 is formed by stacking multiple thermal insulation sheets 119a that are made of a resin material such as polyimide, similarly to the lower mold thermal insulation plate 113. Here, the upper mold thermal insulation plate 119 is constituted by two thermal insulation sheets, and the temperature on the upper mold transfer plate 120 is about 240° C. Accordingly, when the resin sheet 125 is interposed between the upper mold 110 and the lower mold 109, the resin sheet 125 can be sufficiently melted.

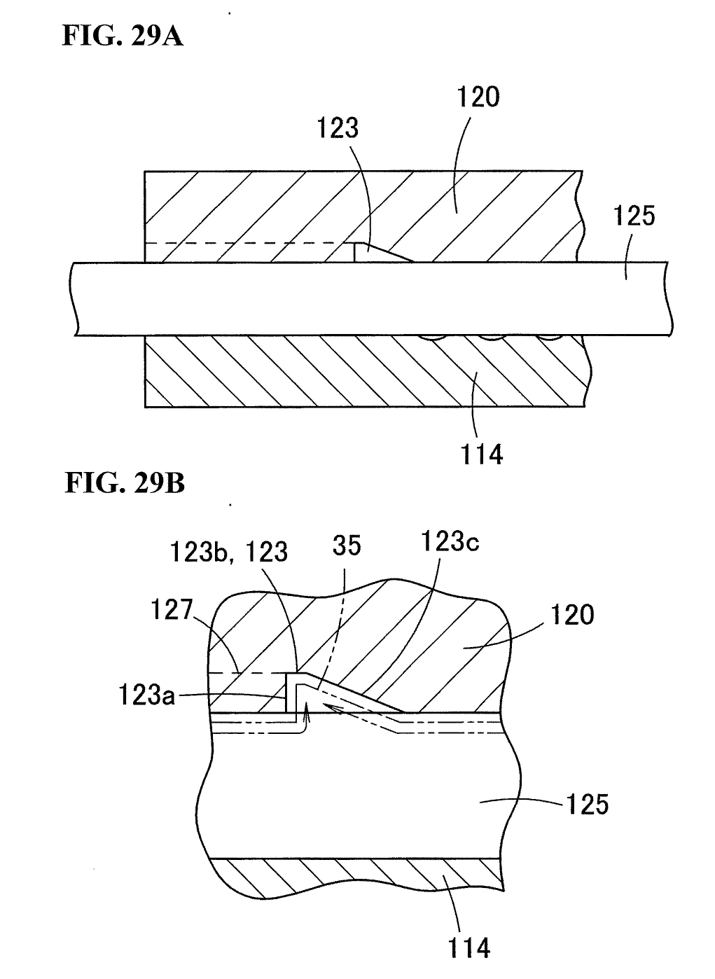

The upper mold transfer plate 120 (first metallic mold) is formed by forming nickel-chrome alloy into a plate shape that is rectangular in a plan view, similarly to the lower mold transfer plate 114. As shown in FIGS. 28A and 29A, a recess 123 that extends in the width direction is formed on the lower face of the upper mold transfer plate 120. As shown in FIG. 29B, the recess 123 is a space surrounded by a vertical face 123a, a bottom face 123b, an inclined face 123c, and two end faces (not shown). The inclined face 123c extends in the width direction. As shown in FIG. 28A, a projecting portion 124 (first pattern of mold) for molding the direction characteristic conversion pattern 36 of the light guide plate 33 is formed on the inclined face 123c. Also, depressions 126a (second pattern of mold) for molding the light emitting portions 40a of the light guide plate 33 are provided on the lower face of the upper mold transfer plate 120. The projecting portion 124 and the depressions 126a are provided such that the same shape is repeated along the width direction of the upper mold transfer plate 120 at a pitch that is equal to the alignment pitch P of the light sources 32.

The protruding portion of the light introduction portion 35 (the portion protruding up beyond the light emission face 39) is formed by a portion of the melted resin sheet 125 flowing into the recess 123. Here, the resin sheet 125 can be anything from an extremely thin film, to a sheet having a thickness of 0.2 to 0.3 mm such as that used in the present embodiment, or something thicker. The height dimension of the protruding portion of the light introduction portion 35 is in the order of less than a millimeter, and here, it is 0.2 mm. The protrusion dimension (surface roughness) of the protruding portion 124 that is formed on the inclined face is in the order of less than a micron, and here, it is 0.2 μm. The area in which the projecting portion 124, the depressions 126a, and the like are formed is the transfer face.

Multiple groove portions 127 that extend from the recess 123 to the side face are formed on the lower face of the upper mold transfer plate 120. According to one or more embodiments of the present invention, the groove portions 127 are formed in a direction (x axis direction) that is orthogonal to the width direction (y axis direction) in which the recess 123 extends. According to this, the length of the groove portions 127 can be minimized. This makes it possible to effectively discharge air bubbles from the groove portions 127. Also, it is sufficient that the depth dimension of the groove portions 127 is greater than or equal to the depth dimension of the recess 123, and here, they are set to the same depth. Also, the width dimension of the groove portions 127 is set to a value by which the outward flow amount of melted resin (resin sheet 125) that has flowed into the recess 123 is suppressed to the minimum required amount and no air bubbles remain in the recess 123. Note that in the case of molding a light guide plate having a shape such as that of Embodiment 2, the groove portions 127 are positioned between locations at which the protruding portions 52 of the light guide plate 33 are to be molded. This takes into consideration the fact that the flow speed of the melted resin is the slowest and air bubbles tend to remain in the region between the locations at which the protruding portions 52 are to be molded. This makes it possible to effectively discharge air bubbles from the recess 123.

Thus, the groove portions 127 that are continuous from the recess 123 to the exterior are formed so as to be in communication with the recess 123, and thus when the melted resin flows into the space inside the recess 123, the resin can be smoothly guided toward the exterior. Moreover, a portion of the resin that flowed into the recess 123 flows outward to the groove portions 127 as well. Furthermore, since the depth dimension of the groove portions 127 is greater than or equal to the depth dimension of the recess 123, no air will remain in the region leading from the recess 123 to the groove portions 127 (if the depth dimension of the groove portions 127 is less than the depth dimension of the recess 123, a corner portion will be formed, and there is a risk that air will remain in that corner portion). Accordingly, air will not remain in the recess 123, and no void will be formed in the light introduction portion 35. Also, even if air remains in the recess 123, it will only be a small amount, and therefore the resin will not be burned. Moreover, it is possible to apply pressure to cause the resin to melt without causing voids to form in the melted resin.

As shown in FIG. 27, the holding plate 121 is formed by forming stainless steel (SUS) into a rectangular frame shape, and an opening portion 128 is formed in the center thereof. The upper mold transfer plate 120 is held to the bottom of the holding plate 121, and the upper mold transfer plate 120 is exposed upward from the opening portion 128. Soft X-rays are emitted by a soft X-ray emission apparatus 129 onto the upper face of the upper mold transfer plate 120 that is exposed from the opening portion 128. This removes electricity from the resin sheet 125 and prevents peripheral dust and the like from being attached due to electrostatic attraction. Rods 130 are connected to the two side portions of the holding plate 121 and can move up and down independently of the overall up and down movement of the upper mold due to a driving means such as a cylinder or the like (not shown) being driven.

The overall up and down movement of the upper mold is performed by a press apparatus 131 that is arranged on the upper face of the upper mold support plate 117. In the press apparatus 131, rods 130 (not shown) move up and down due to air being supplied and discharged from an air supply apparatus 132, and thereby the entire upper mold is cause to move up and down via the upper mold support plate 117.

The resin sheet 125 that is supplied by the material supply apparatus 101 is conveyed between the upper mold 110 and the lower mold 109. At an intermediate position on the conveyance path of the resin sheet 125, a support roller 133 that supports the lower face of the resin sheet 125, and a positioning gripper 134 that grips the resin sheet from above and below are elevatably arranged in the stated order starting from the vicinity of the mold at the entrance and exit sides of the mold. Also, a conveyance gripper 135 is arranged on the downstream side of the conveyance path. The conveyance gripper 135 grips the resin sheet 125 from above and below similarly to the positioning gripper 134 and moves back and forth along the conveyance path according to the driving means (not shown). When the positioning gripper 134 releases the resin sheet 125, the resin sheet 125 is gripped by the conveyance gripper 135 and moved downstream of the conveyance path, and it is thereby possible to convey the resin sheet 125. Operations of the support rollers 133 and grippers will be described later.

Also, an air supply duct 136 is arranged above on the upstream side of the mold and an air discharge duct 137 is arranged above on the downstream side. Air supplied by a compressor or the like (not shown) is blown out from the air supply duct 136 and is blown from obliquely above onto the resin sheet 125 that is positioned between the upper mold 110 and the lower mold 109. The air discharge duct 137 sucks air using a compressor or the like (not shown) and recovers air blown onto the resin sheet 125 from the air supply duct 136. The air supplied from the air supply duct 136 has been purified, and the airflow formed between the air supply duct 136 and the air discharge duct 137 not only cools the resin sheet 125 but also forms a so-called air barrier that prevents dust and the like from attaching to the surface of the resin sheet 125. Also, since electricity has been removed from the resin sheet 125 by emitting the soft X-ray described above, dust and the like is not attached thereto due to electrostatic attraction.

As shown in FIG. 26, adhesive rollers 138 that come into contact with the upper and lower faces of the resin sheet 125 are arranged on the upstream side of the mold. The adhesive rollers 138 convey the resin sheet 125 by rotating and remove dust and the like that is attached to the surface thereof.

The film adhesion apparatus 103 adheres a protective film 139 to the upper and lower faces of the resin sheet 125 that has undergone transfer molding. The protective film 139 prevents damage to the resin sheet 125 caused by colliding with another member, and prevents dust and the like from attaching to the surface.

The cutting apparatus 104 is for cutting the resin sheet 125 that has undergone transfer molding into strips. After being cut by the cutting apparatus 104, four sides of the resin sheet 125 are cut by a punching apparatus (not shown) and the resin sheet 125 is a semi-finished plate 146. Cutting margins that are to be removed remain on the end face of the light introduction portion 35 and the opposite side thereof in the semi-finished plate 146.

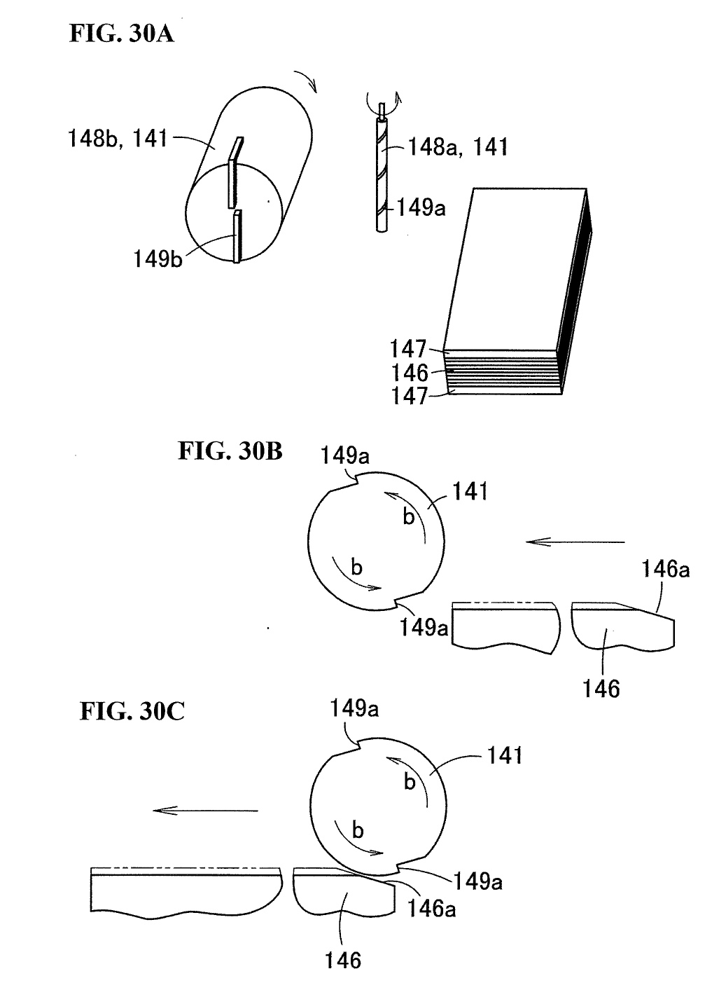

The external shape processing apparatus 105 includes a cuffing member 141 for cutting the two side faces of the semi-finished plate 146 (the side faces of the light introduction portion 35 and the opposite side thereof). As shown in FIG. 30A, the cutting member 141 has a first cutting tool 148a and a second cutting tool 148b. The cutting tools 148a and 148b are driven so as to rotate by the driving means (not shown). The first trimming tool 148a is a cylindrical tool for giving a rough finish and a spiral-shaped cutting blade 149a is formed on the outer circumferential face thereof. The second cutting tool 148b is a disk-shaped tool for giving a specular surface finish, and notches are formed at two symmetrical positions on the outer circumference and a cutting blade 149b that extends in the radial direction is formed on the surface. Note that the specific cutting method used by the cutting member 141 will be described later.

Molding Operation of Embodiment 4

Operations performed by the light guide plate forming apparatus with the above-described configuration will be described next.

Preparation Step

The upper mold 110 is raised to release the resin sheet 125 from the mold, and the leading edge portion of the resin sheet 125 that was supplied from the material supply apparatus 101 is gripped by the conveyance gripper 135. Then, after the conveyance gripper 135 is moved, the resin sheet 125 is gripped by the positioning gripper 134 and the resin sheet 125 is thereby arranged in a region in which the upper mold 110 and the lower mold 109 oppose each other (conveyance step).

The mold is heated by energizing the heater 115 in advance. As described above, due to the interposition of the thermal insulation plates, the upper mold transfer plate 120 is around 240° C. in the upper mold 110, and the lower mold transfer plate 114 is around 150° C. in the lower mold 109. The resin sheet 125 is positioned close to the lower mold 109, and the upper face of the lower mold 109 is suppressed to around the glass-transition temperature, and therefore defects such as the resin sheet 125 bending downward due to the influence of the heat and coming into contact with the lower mold transfer plate 114 will not occur (pre-heating step).

Transfer Molding Step

Here, the resin sheet 125 is placed on the lower mold transfer plate 114 of the lower mold 109 due to the support roller 133 and the positioning gripper 134 being lowered. Also, the press apparatus 131 is driven to lower the upper mold 110, and the transfer face of the upper mold transfer plate 120 is brought into contact with the lower mold 109. At this time, the pressure applied by the press apparatus 131 is suppressed to a small value, and the resin sheet 125 is in a state of being gently sandwiched between the molds. According to this, the resin sheet 125 is heated, and thus moisture included on the surface layer portion thereof is removed (pre-heating step).

When a pre-set time period (first set time period) elapses from the start of the pre-heating step, the amount of pressure applied by the press apparatus 131 is increased. As described above, polycarbonate (melting point=approximately 250° C., glass-transition temperature=approximately 150° C.) is used for the resin sheet 125. Since the temperature of the upper mold transfer plate 120 has risen to 240° C., the melting point of the resin sheet 125 is exceeded, and the resin sheet 125 enters a melted state. Although the temperature of the lower mold transfer plate 114 is 180° C. in the lower mold 109, no heat escapes from the lower mold side since the lower mold thermal insulation plate 113 has been arranged therein. For this reason, the entire region of the resin sheet 125 that is enclosed in the mold exceeds the melting point and enters the melted state (heating/pressing step).

Pressure is applied by the press apparatus 131 from the upper mold 110. According to this, the portion of the resin sheet 125 that is enclosed in the mold decreases in thickness and a portion thereof (upper face portion) flows into the recess 123 that is formed on the upper mold transfer plate 120. When the melted resin flows into the recess 123, the air in the recess 123 is discharged to the exterior via the groove portions 127. Then, the interior of the recess 123 is completely filled with melted resin, and a portion thereof flows out to the groove portions 127. The groove portion 127 is formed so as to have a depth that is greater than or equal to the depth of the recess 123 (the depths are the same here). Because of this, air does not remain in the recess 123 and is smoothly discharged to the exterior. Also, since the air is not compressed in the recess 123, problems such as burning may not occur. Furthermore, even if a minute quantity of air remains in the recess 123, since sufficient pressure is applied, it is possible to melt the resin without causing voids to be formed in the melted resin.

When a pre-set time period (second set time period) elapses from the start of the heating/pressing step, the upper mold 110 is raised. Note that the upper mold transfer plate 120 remains in contact with the resin sheet 125 due to the cylinder being driven. Here, air is supplied onto the upper mold transfer plate 120 via the air supply duct 136. The heated upper mold support plate 117 is brought away from the resin sheet 125, and air is blown from the air supply duct 136 onto the upper mold transfer plate 120. In other words, the resin sheet 125 can be cooled via only the upper mold transfer plate 120. Accordingly, since the heat from the upper mold support plate 117 has no influence on the cooling of the resin sheet 125, cooling can be effectively performed in a short amount of time. That is to say, the resin sheet 125 can be cooled in a short amount of time to 150° C. or lower, which is the glass-transition temperature of the polycarbonate used in the resin sheet 125. In this case, since the upper mold support plate 117 and the upper mold intermediate plate 118 are not cooled, there is little energy loss, and the subsequent transfer molding step can be started smoothly in a short amount of time (cooling step).

When a pre-set time period (third set time period) elapses from the start of the cooling step, or in other words, when the cooling causes the melted resin to solidify and the shape stabilizes, the upper mold transfer plate 120 is raised and is separated from the molded portion. Also, the support roller 133 is raised and the molded portion is separated from the lower mold transfer plate 114 as well. According to this, the light introduction portion 35 with a height in the order of less than a millimeter, or in other words, 0.2 mm is formed on the upper face of the resin sheet 125. Also, multiple direction characteristic conversion patterns 36 with a sawtooth shape in the order of less than a micron, or in other words, 14 μm are formed on the inclined face 37 of the light introduction portion 35. Also, the light emitting portions 40a are formed on the light emission face 39 of the light guide plate 33. On the other hand, multiple semicircular light emission portions 40b are formed on the lower face of the resin sheet 125 (mold separation step).

Conventionally, it has been possible to form the direction characteristic conversion patterns 36 in the order of less than a micron using transfer molding on the resin sheet 125, but it has not been possible to form the light introduction portion 35 in the order of less than a millimeter at the same time. By using the transfer molding apparatus 102 that includes the mold structure, it is possible to form the direction characteristic conversion patterns 36 in the order of less than a micron and the light introduction portion 35 in the order of less than a millimeter at the same time on the resin sheet 125. Also, with transfer molding, the entirety of the resin sheet 125 that is enclosed between the molds is melted, and therefore no internal stress remains in the semi-finished plate 146 that is obtained by curing at a later time. Accordingly, when multiple LEDs are arranged on the end face side of the light introduction portion 35 and light is passed therethrough, the entire upper face (light emission face 39) with the exception of the light introduction portion 35 can be caused to emit light uniformly by eliminating unevenness and the like.

Film Adhesion Step

After being subjected to transfer molding by the transfer molding apparatus 102, the resin sheet 125 is furthermore conveyed to the downstream side and a protective film 139 is adhered to the upper and lower faces of the resin sheet 125 in the film adhesion apparatus 103. The protective film 139 prevents damage such as the semi-finished plate 146 getting scratched due to colliding with another member or the like, and prevents defects caused by peripheral dust or the like being attached. The protective film 139 is peeled off when the liquid crystal panel is to be attached after the semi-finished plate 146 undergoes subsequent steps and becomes a light guide plate.

Cutting Step

After the protective film 139 is adhered to the two faces of the resin sheet 125, the resin sheet 125 is furthermore conveyed to the downstream side, is cut in the conveyance direction in units of semi-finished plates and becomes a strip shape in the cutting apparatus 104. The semi-finished plate 146 has the cutting margin from the outer shape processing step on the end face of the light introduction portion 35 and the opposite side thereto (cutting face). At this time, a tapered face 146a is formed at the corner portion on the cutting direction side according to a later-described first cutting tool 148a on the cutting face of the semi-finished plate 146. Here, the tapered face 146a has an angle of about 3° with respect to the cutting face and is formed such that the tapered portion remains after the cutting margin is cut off.

Outer Shape Processing Step

After being obtained in the cutting step, around eight semi-finished plates 146 are stacked such that the light introduction portions 35 are alternatingly positioned at opposite sides. Also, dummy plates 147 are arranged on the upper and lower faces of the stacked semi-finished plates 146.

Next, one end face of the semi-finished plate 146 and the dummy plate 147 are cut off by the first cutting tool 148a and then by the second cutting tool 148b.

As shown in FIG. 30A, the first cutting tool 148a is positioned such that the rotation axis is parallel with the cutting face of the semi-finished plate 146, and the end face of the semi-finished plate 146 is cut off by the outer circumferential cutting blade 149a while rotating in the counter-clockwise direction shown in the figure. In this case, the semi-finished plates 146 are stacked and sandwiched between the dummy plates 147. Accordingly, floppiness and the like does not occur at the time of cutting, and it is possible to perform cutting smoothly. Also, the tapered face 146a is formed on the corner portion of the side in the direction of cutting performed by the first cutting tool 148a on the semi-finished plate 146. Moreover, the tapered face 146a is in a range exceeding the cutting margin on the cutting face of the semi-finished plate 146. Accordingly, burrs are not formed by the first cutting tool 148a at the corner portion of the semi-finished plate 146.

As shown in FIGS. 30B and 30C, the second cutting tool 148b is arranged such that the rotation axis is perpendicular to the cutting face of the semi-finished plate 146, and the cutting blade 149b on the surface thereof gives the cutting face a specular surface finish. The cutting blade 149b cuts the cutting face of a stacked semi-finished plate 146 while rotating. Accordingly, if the dummy plates 147 have not been arranged on the upper and lower faces of the semi-finished plates 146, there is a risk that burrs will appear on the upper and lower edges of the semi-finished plates 146 that are arranged at the two ends. However, the dummy plates 147 are provided. For this reason, if burrs are formed, they are located on the dummy plates 147 and not on the semi-finished plates 146.

The light guide plate 33 that is completed in this way is constituted by the 0.2 mm-thick light guide plate body 34, and a 0.5 mm-thick light introduction portion 35 whose cross section is approximately trapezoidal. The multiple semi-spherical light emitting portions 40a and 40b are formed on the upper face and lower face of the light guide plate 33.

Note that as described above, when performing transfer molding, the entirety of the resin sheet 125 that is sandwiched between the molds is melted, and therefore when the product is obtained, internal stress does not remain, and the structural state is uniform. Accordingly, according to the light guide plate 33 that was molded in this way, it is possible to evenly emit P-polarized light and S-polarized light from the entirety of the light emission face 39. That is to say, it is possible to vastly reduce the difference in light transmittance amounts between P-polarized light and S-polarized light that is emitted from the light guide plate 33.

### Embodiment 5

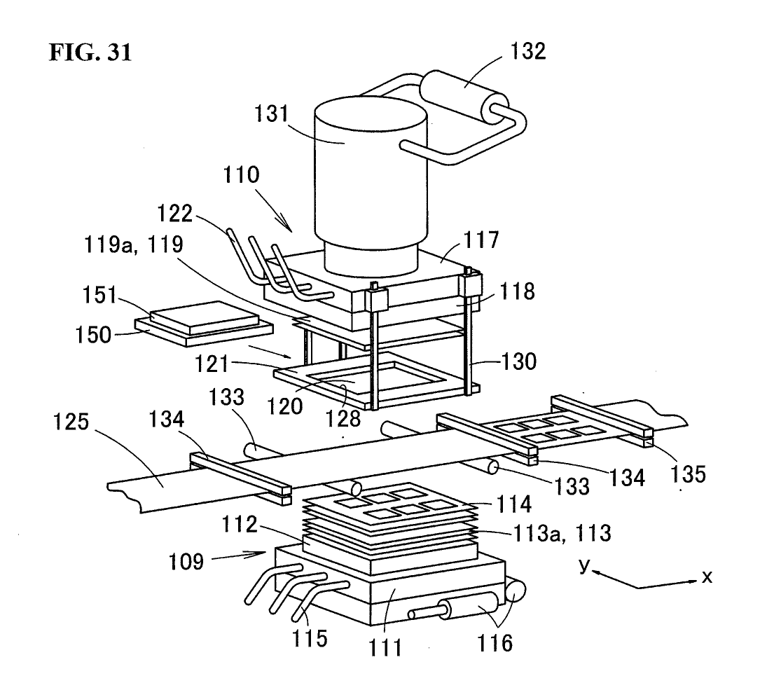

Another transfer molding apparatus for molding a light guide plate will be described next. In FIG. 31, a direct cooling method of cooling by bringing a cooling plate 150 into direct contact is employed instead of the air cooling method using air blown from the air supply duct 136 onto the upper mold transfer plate 120.

That is to say, the cooling plate 150 can move back and forth between the transfer region in the mold and the non-transfer region outside of the mold by means of a horizontal movement mechanism (not shown). A supplementary thermal insulation plate 151 is integrated on the upper face of the cooling plate 150. When held by the holding plate 121, the lower face of the upper mold transfer plate 120 can be brought into contact with the upper face of the resin sheet 125, and the upper face can be brought into contact with the lower face of the cooling plate 150. The cooling plate 150 uses a water cooling method and is configured such that the surface temperature of the cooling plate 150 is maintained at a constant value (e.g., 20° C.) due to liquid flowing through a pipe (not shown). Note that the other configurations of the mold and the like are similar to those in Embodiment 4, and therefore the same reference numerals are used to denote the corresponding portions, and the description thereof will not be repeated.

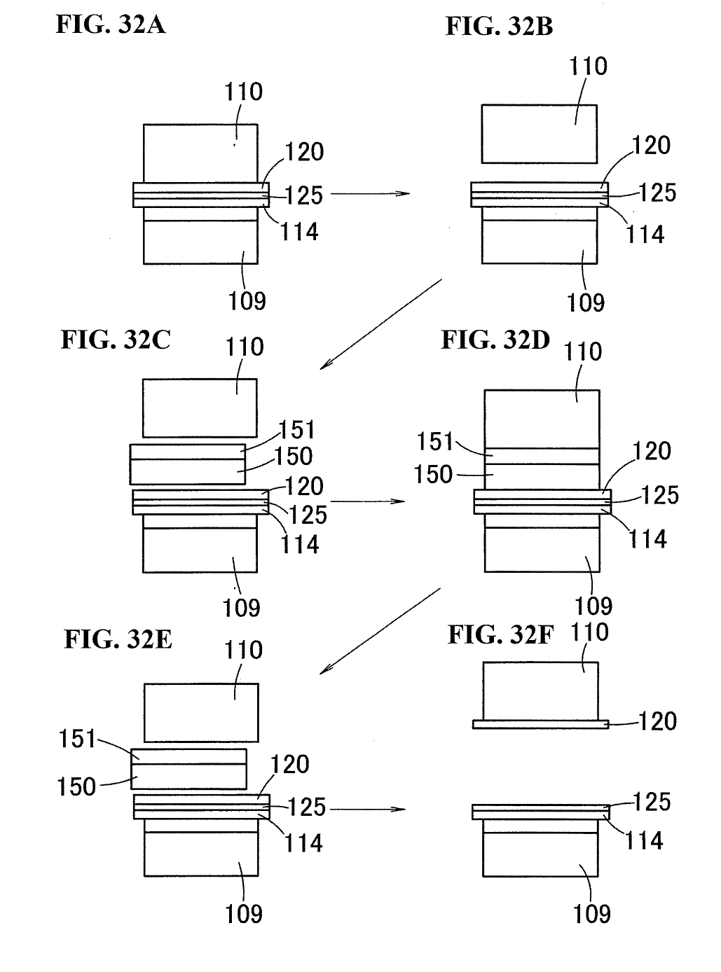

With the configuration that includes the cooling plate 150, cooling is performed as follows after the resin sheet 125 is heated and pressed. That is to say, in the transfer molding step, when transitioning from the state shown in FIG. 32A to the cooling step, after the upper mold 110 is raised while the state in which the upper mold transfer plate 120 is in contact with the resin sheet 125 as shown in FIG. 32B is maintained, the cooling plate 150 is inserted from the side between the upper mold transfer plate 120 and the upper mold intermediate plate 118 as shown in FIG. 32C.

First Cooling Step

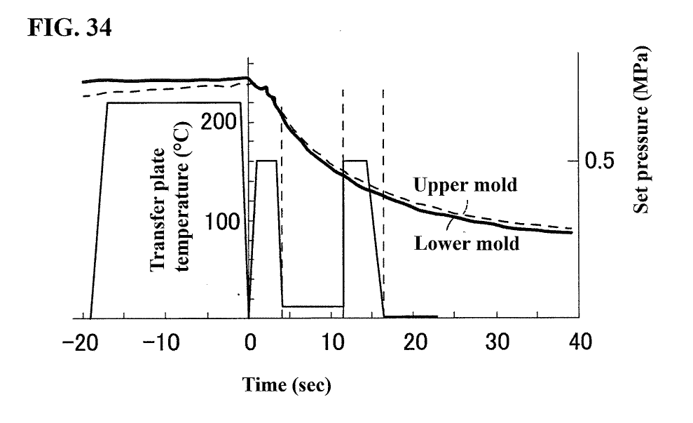

As shown in FIG. 32D, the lower face of the cooling plate 150 is brought into contact with the upper face of the upper mold transfer plate 120, and the cooling plate 150 and the supplementary thermal insulation plate 151 are sandwiched between the upper mold transfer plate 120 and the upper mold intermediate plate 118. As shown in FIG. 34, the applied pressure at this time is high (lower than at the time of heating/pressing) such that air bubbles (voids) can be eliminated from the resin sheet 125 (e.g., an applied pressure of at least 0.8 MPa is used according to the combined gas law, such that the diameter of air bubbles that are around 0.4 mm in diameter can be reduced to around 0.1 mm).

Second Cooling Step

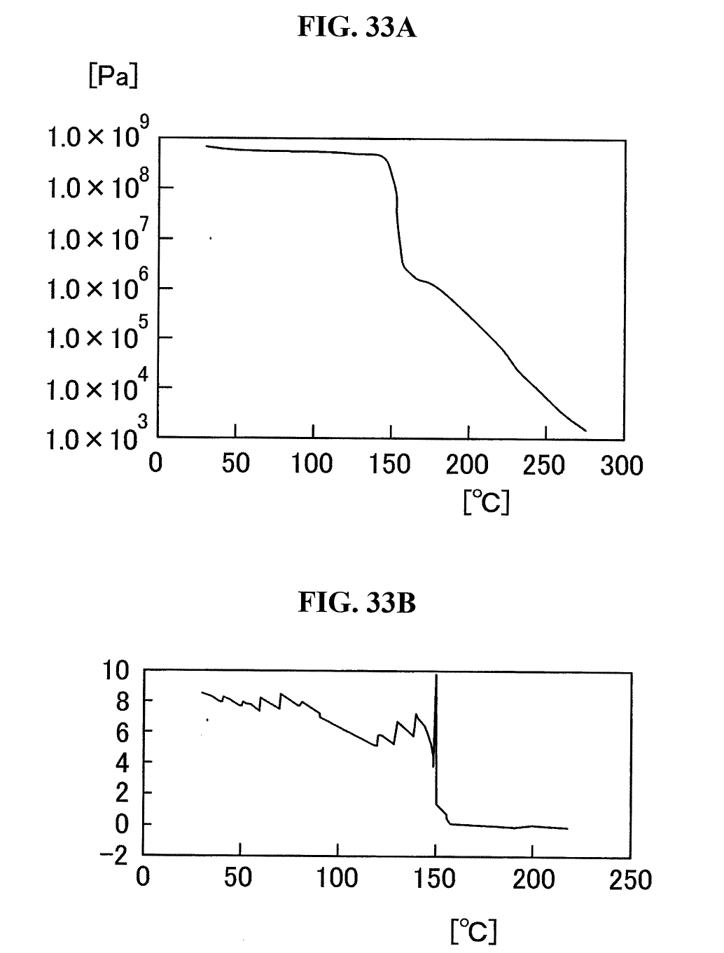

Subsequently, when the temperature of the resin sheet 125 falls below the melting point (e.g., 200° C.) (managed in terms of time here, at the point in time when the first set time period has elapsed from the start of the first cooling step), the applied pressure drops all at once (e.g., the applied pressure becomes 0.1 MPa). As shown in FIG. 33A, the elasticity modulus of the resin sheet 125 increases along with a temperature drop, the resin sheet 125 becomes less likely to undergo elastic deformation, solidifies at around 150° C., which is the glass-transition temperature, and fluidity is eliminated. For this reason, as shown in FIG. 33B, if the resin sheet 125 is in a state in which pressure is being applied by the mold when the temperature has dropped to around 150° C., residual stress will occur. In actuality, starting at around 200° C., the resin sheet 125 becomes a rubber-like elastic material and residual stress occurs. Here, in the present embodiment, the residual stress is removed by reducing the pressure when the temperature of the resin sheet 125 is reduced to around 200° C.

Third Cooling Step

Subsequently, when the temperature of the resin sheet 125 is furthermore reduced to the glass-transition temperature or lower (e.g., 150° C.) (managed in terms of time here, at the point in time when the second set time period has elapsed from the start of the second cooling step), the applied pressure is once again raised (e.g., the applied pressure is set to 0.5 MPa or higher). Since the resin sheet 125 is cooled from the upper face side, it is unavoidable that the temperature distribution will vary. At the point in time when the upper face side of the resin sheet 125 has solidified first due to the temperature thereof dropping to the glass-transition temperature or below, the temperature of the lower face side sometimes has not decreased to the same extent. In such a case, the solidified upper face side does not follow the thermal contraction of the lower face side of the resin sheet 125 and warping occurs in the shape of a curve that peaks in the central portion of the lower face. However, it is possible to mandatorily cancel out the compression stress by once again increasing the applied pressure.

In this way, when this cooling method is employed in Embodiment 4, it is possible to shorten the cooling time in comparison with the air cooling in the case of Embodiment 4. Specifically, the 110-second cooling time in the case of the air cooling in Embodiment 4 can be shortened to 55 seconds in the case of the direct cooling in Embodiment 5. Also, in addition to the thermal insulation plates being arranged on the upper mold 110 and the lower mold 109, the supplementary thermal insulation plate 151 is integrally arranged on the upper face of the cooling plate 150. For this reason, even if the cooling plate 150 is low in temperature, the influence of the upper mold 110 can be suppressed, and the reversion time until the subsequent heating/pressing time can be shortened.

When the resin sheet 125 is cooled as described above, as shown in FIG. 32E, the upper mold 110 is raised, and the cooling plate 150 is moved horizontally and retracted. Then, as shown in FIG. 32F, the upper mold transfer plate 120 is raised, thereby ending one cycle.

### Embodiment 6

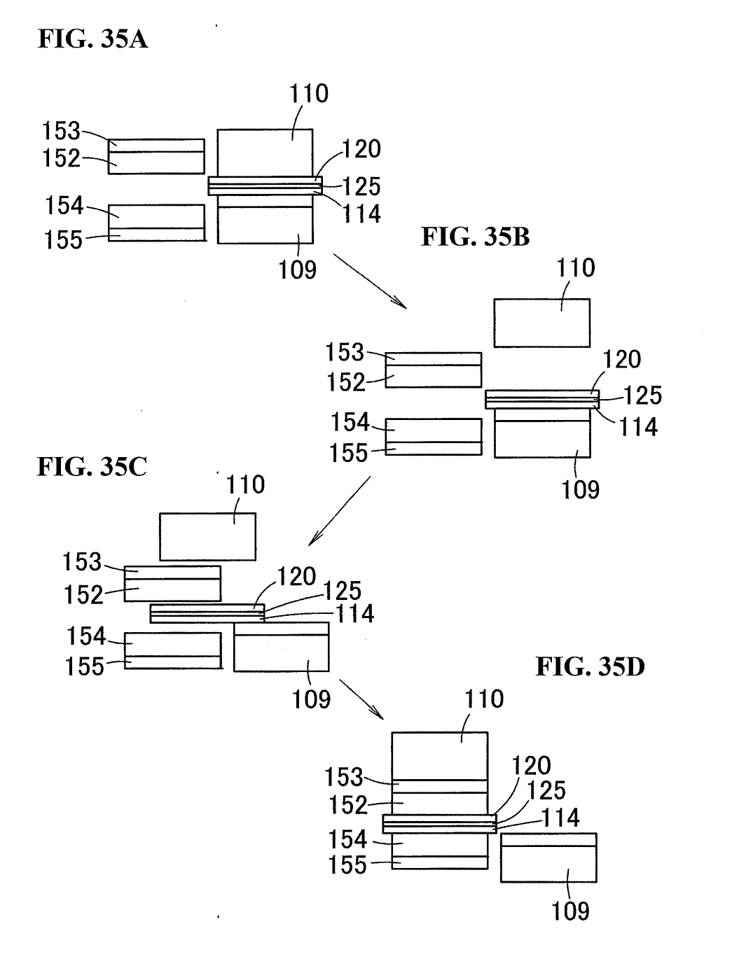

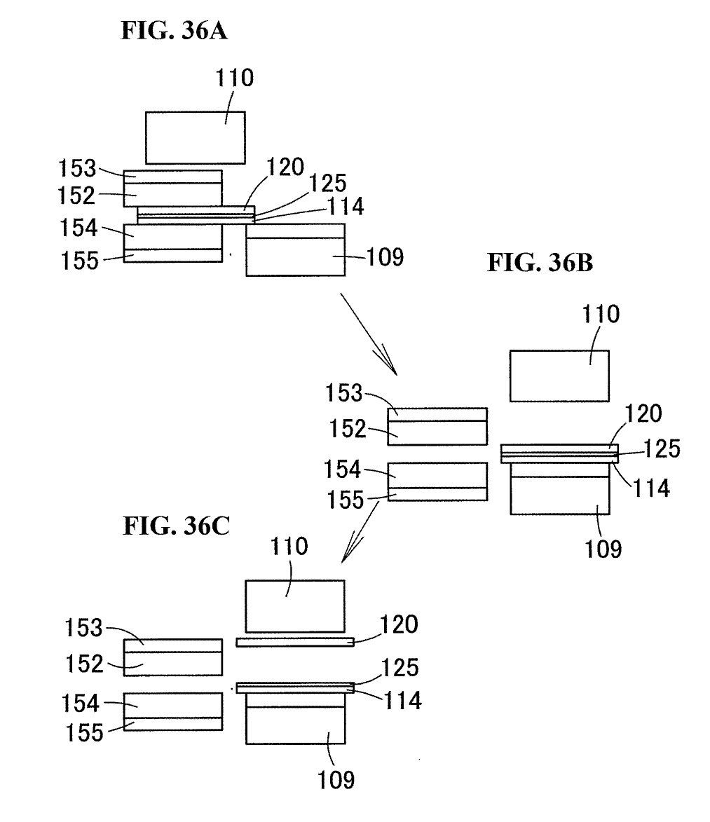

Yet another transfer molding apparatus will be described below. As shown in FIGS. 35 and 36, this transfer molding apparatus includes a cooling mechanism that cools the resin sheet 125 from above and below by cooling not only from the upper face side of the upper mold transfer plate 120, but also from the lower face side of the lower mold transfer plate 114.

That is to say, in Embodiment 5, only the cooling plate 150 was provided with the supplementary thermal insulation plate 151 integrated with the upper face, whereas in Embodiment 6, in addition to a first cooling plate 152 with a supplementary thermal insulation plate 153 integrated on the upper face, which corresponds to the cooling plate 150 in Embodiment 5, a second cooling plate 154 with a supplementary thermal insulation plate 155 integrated on the lower face is included. Also, the entire lower mold with the exception of the lower mold transfer plate 114 can move to an retraction position in a horizontal direction. Also, when the first cooling plate 152 and the second cooling plate 154 oppose each other in the up-down direction and the resin sheet 125 has the upper mold transfer plate 120 in contact with its upper face and the lower mold transfer plate 114 in contact with its lower face, the first cooling plate 152 and the second cooling plate 154 can be inserted above and below the resin sheet 125.

Operations of the transfer molding apparatus 102 that includes the cooling mechanism with the above-described configuration are as follows. That is to say, similarly to Embodiment 4 and Embodiment 5, when the pre-heating step and the transfer molding step end as shown in FIG. 35A, the upper mold 110 is raised while the state in which the upper mold transfer plate 120 is in contact with upper face of the resin sheet 125 is maintained as shown in FIG. 35B. Then, as shown in FIG. 35C, portions other than the lower mold 109 are moved to the retraction position in the horizontal direction while the state in which the lower mold transfer plate 114 is in contact with the lower face of the resin sheet 125 is maintained. Also, the upper mold transfer plate 120 and the lower mold transfer plate 114 that are arranged opposing each other in the up-down direction are moved in the horizontal direction and are arranged above and below the resin sheet 125 that has the upper mold transfer plate 120 and the lower mold transfer plate 114 in contact with its upper and lower faces. As shown in FIG. 35D, in this state, the upper mold 110 is lowered, and the resin sheet 125 whose upper and lower faces are in contact with the upper mold transfer plate 120 and the lower mold transfer plate 114 respectively is held between the first cooling plate and the second cooling plate. Then, when pressed, the cooling step for the resin sheet 125 is started.

In this way, in the cooling step, the resin sheet 125 can be cooled evenly from above and below. Accordingly, it is not necessary to address problems such as warping according to the first to third cooling steps as performed in Embodiment 5. In other words, a semi-finished plate 146 without warping or the like can be completed with a single cooling step.

Subsequently, when the cooling step ends, as shown in FIG. 36A, the first cooling plate 152 and the second cooling plate 154, and portions excluding the lower mold transfer plate 114 of the lower mold 109 are moved horizontally and returned to their original positions. Then, when the resin sheet 125 whose upper and lower faces are in contact with the upper mold transfer plate 120 and the lower mold transfer plate 114 respectively is positioned on the lower mold 109 as shown in FIG. 36B, the upper mold transfer plate 120 is raised as shown in FIG. 36C, whereby one cycle ends.

### Other Embodiments

Note that the present invention is not limited to the configuration described in the above embodiments, and various modifications are possible.

For example, in the above embodiments, the light introduction portion 35 is fainted by causing the resin sheet 125 to melt and causing a portion of the melted resin to flow into the recess 123 formed on the upper mold transfer plate 120, but the light introduction portion 35 may be formed as follows.

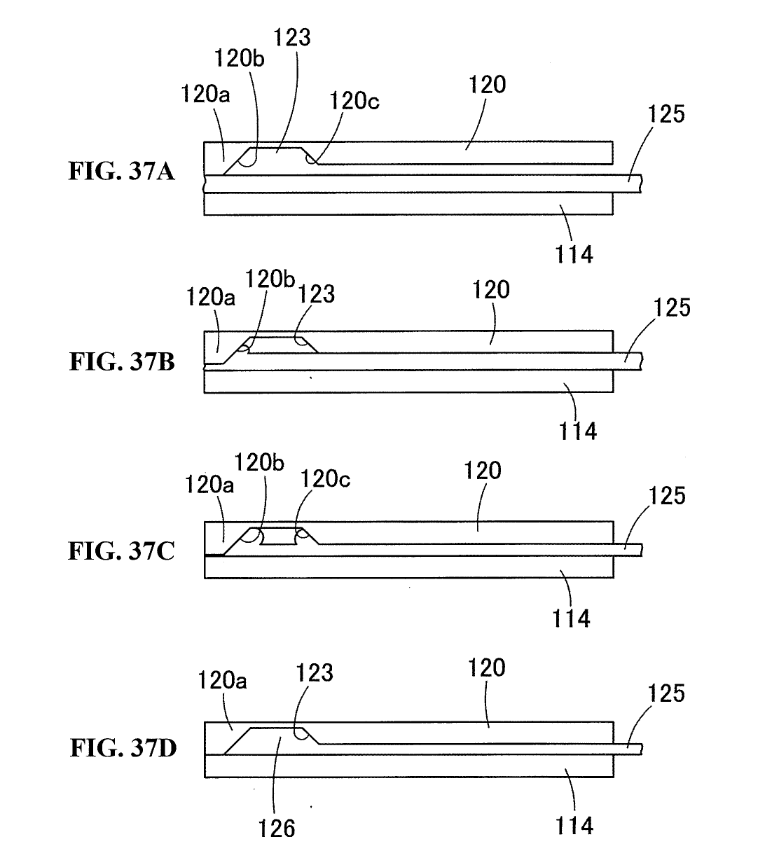

In FIG. 37A, in the resin sheet 125, it is possible to allow mainly the melted resin in non-product portions (portions other than the region that is to be the light guide plate) to flow into the recess 123. That is to say, a side wall portion 120a on the side of the non-product portion that is to constitute the recess 123 formed on the upper mold transfer plate 120 is formed so as to be greater in height than other portions. Also, an interior side face 120b formed by the side wall portion 120a is constituted by an inclined face such that it gradually opens from the bottom face side of the recess 123.

According to this, when the molds are brought into close contact with each other and pressed at the time of transfer molding as shown in FIG. 37B, the melted resin in the non-product portion flows over the inclined face 120b of the side wall portion 120a and flows into the recess 123 as shown in FIG. 37C. Then, a portion of the resin on the manufactured portion side flows over the inclined face 120c of the side wall portion of the opposite side and flows into the recess 123. In this case, the protrusion dimension of the side wall portion 120a has been increased, and it is therefore possible to sufficiently increase the influx amount of melted resin in the non-product portion. Accordingly, the amount of wasted resin can be suppressed and cost can be reduced. As a result, as shown in FIG. 37D, the recess 123 is filled with melted resin. The cooling step and the like thereafter are similar to those of the above-described embodiments and therefore the description thereof will not be repeated here.

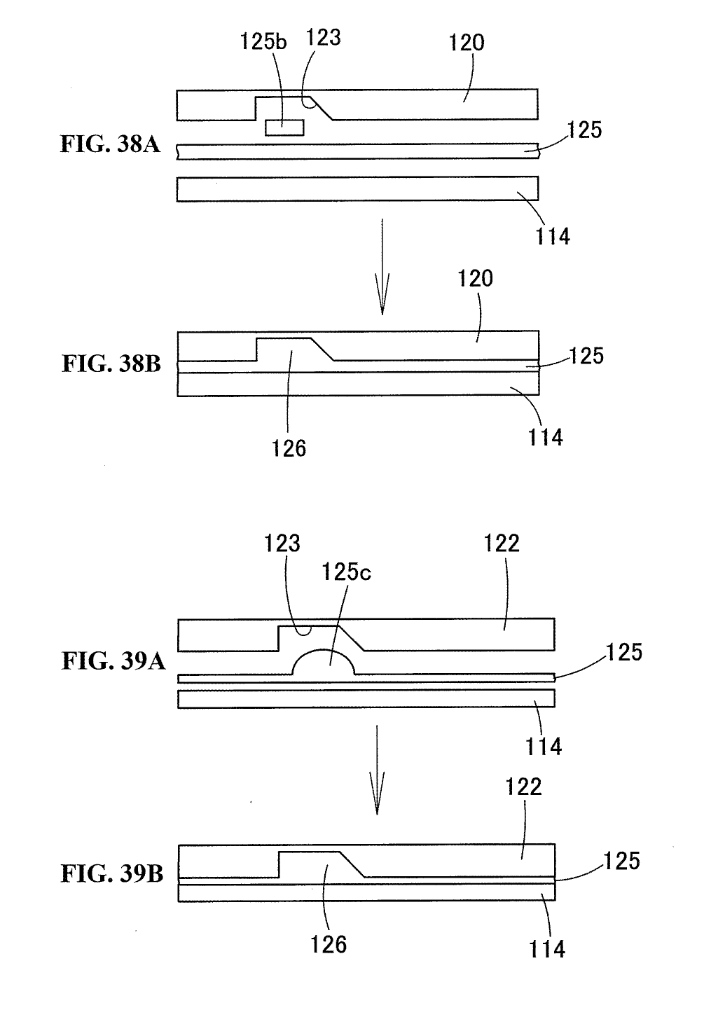

In FIG. 38A, it is not the case that the resin sheet 125 is melted and a portion of the melted resin is allowed to flow into the recess 123, but rather additional materials are supplied (e.g., resin fragments 125b) in addition to the recess 123 in the upper mold transfer plate 120. This makes it possible to easily form the light introduction portion 35 without difficulty, as shown in FIG. 38B.

In FIG. 39A, a configuration is used in which an additional member is integrated in advance by forming a protruding portion 125c in advance on a portion of the resin sheet 125. As the thickness dimension of the protruding portion 125c, according to one or more embodiments of the present invention, a value is used that is smaller than the thickness dimension of the light introduction portion 35 and larger than the thickness dimension of the resin sheet 125 before the transfer molding. In this way, according to the configuration including the protruding portion 125c, no mechanism for supplying additional materials is needed and workability can be improved.

Also, in the embodiments, the recess 123 is formed on the upper mold transfer plate 120, but it can be provided on the lower mold transfer plate 114, or it can be provided on both of them.

Also, in the embodiments, a mold structure comprised of the upper mold 110 and the lower mold 109 was employed, but it is also possible to employ a mold that opens and closes in a horizontal direction, for example.

Also, in the embodiments, a transfer face is faulted on both the upper mold transfer plate 120 and the lower mold transfer plate 114, but it can be formed on just one of the transfer plates as well. Also, it is also possible to form the transfer surface directly on the mold (e.g., the intermediate plate) without the transfer plates.

Also, in the embodiments, the entirety of the upper mold transfer plate 120 is heated uniformly, but it does not necessarily need to be heated uniformly. For example, a configuration is also possible in which the proximity of the recess 123 is heated in a focused manner. According to this, it is possible to obtain a preferable melted state for the resin in the recess 123 and to form a preferable light introduction portion 35 in which shrinkage and the like does not occur.

Also, in the embodiments, the resin sheet 125 is sandwiched between the upper mold transfer plate 120 and the lower mold transfer plate 114 and is heated and pressed, and the entirety of the resin sheet 125 is melted. For this reason, according to one or more embodiments of the present invention, at least one of the transfer plates 120 and 114 includes a flow regulation structure for regulating the flow of the melted resin on the circumferential edge portion thereof.

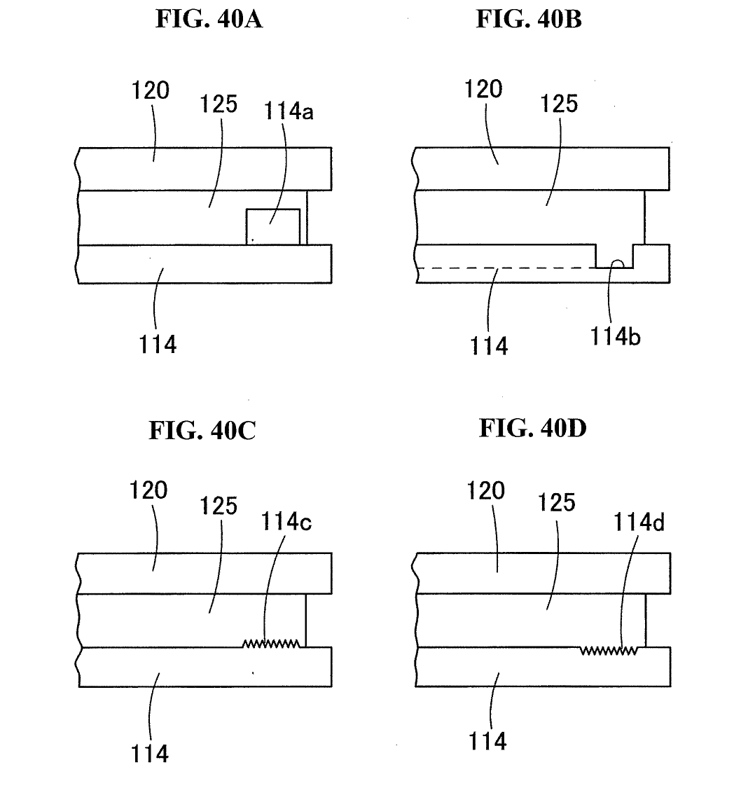

In FIG. 40, the flow regulation structure is farmed on the circumferential edge portion of the upper face of the lower mold transfer plate 114. Note that the flow regulation structure does not necessarily need to be formed so as to surround all four sides, or in other words, if the flowing resin does not flow in the surrounding area, it is also possible to provide it intermittently, and to provide it only at the two side portions.

FIG. 40A shows a flow regulation structure that is constituted by a projecting portion 114a that projects from the upper face of the lower mold transfer plate 114. FIG. 40B shows a flow regulation structure that is constituted by a groove portion 114b that is formed on the upper face of the lower mold transfer plate 114. FIG. 40C shows a flow regulation structure that is constituted by minute projecting portions 114c that project from the upper face of the lower mold transfer plate 114. FIG. 40D shows a flow regulation structure that is constituted by many minute recessed portions 114d that are formed on the upper face of the lower mold transfer plate 114. These configurations may be formed on the upper mold transfer plate 120, and they may be formed on both of the transfer plates 114 and 120. Also, the configuration is not limited to these modes, and any mode may be employed if it increases the flow resistance of the melted resin.

Also, in the embodiments, the applied pressure in the cooling step is determined as shown in FIG. 34, but it may be determined as follows.

For example, in the first cooling step, applied pressure P1 is determined according to the combined gas law (PV/T=constant) in order to compress the diameter of air bubbles with a diameter of 0.4 mm to a diameter of 0.1 mm.

P0×V0/T0=P1×V1/T1 (1)

The following values are substituted into equation (1).

P0=101325 Pa (atmospheric pressure)

V0=3.35×10⁻¹¹ m³ (volume of air bubble with diameter of 0.4 mm)

T0=240° C.=513 K

V1=5.23×10⁻¹³ m³ (volume of air bubble with diameter of 0.1 mm)

T1=190° C.=463 K

According to the above equation, P1=5.85 MPa is acquired.

Accordingly, by setting the applied pressure to 5.85 MPa or higher, air bubbles with a diameter of 0.4 mm can be compressed so as to have a diameter of 0.1 μm or less.

Also, in the second cooling step, due to the temperature of the resin sheet 125 (polycarbonate) dropping to 190° C., the applied pressure drops to 0.02 MPa (0 MPa, or in other words, a state of no applied pressure is also possible). This removes residual stress.

Furthermore, in the third cooling step, the pressure that corresponds to the compression stress at the time when the temperature of the resin sheet 125 (polycarbonate) drops from 150° C., which is the glass-transition temperature, to 130° C., at which the resin sheet 125 can be removed from the mold, is set as applied pressure P2. That is to say,

P2=E×α

E (elasticity coefficient)=2.45 GPa

α (linear expansion coefficient of polycarbonate)=7×10⁻⁵

Accordingly, P2=3.4 MPa, and if pressure is applied at a value greater than or equal to this value (e.g., 6.2 MPa), it is possible to prevent deformation caused by the compression stress of the resin sheet 125 that accompanies cooling.

Also, in the embodiments, the preparation step, the transfer molding step, the film adhesion step, and the cutting step are performed successively by a series of apparatuses in a line, but each step may be performed individually, and a portion of the steps may be performed successively. That is to say, it is sufficient that this series of steps can be executed sequentially, regardless of whether they are executed successively or not. Also, the steps in the transfer molding step may be performed individually as well, and a portion thereof may be performed successively.

Also, in the present embodiment, the maximum height of the relief formed on the transfer face is in the order of less than a micron, and the protrusion dimension of the thick portion 126 is in the order of less than a millimeter, but the present invention is not limited to this, and for example, the maximum height of the relief may be in the order of microns (e.g., 200 μm), and in the order of less than a millimeter (e.g., 1 mm). In short, it is sufficient that the protrusion dimension of the thick portion 126 is greater than the maximum height of the relief. In particular, according to one or more embodiments of the present invention, the protrusion dimension of the thick portion 126 is greater than the maximum height of the relief by a factor of at least 10. The protrusion dimension of the thick portion 126 may be in the order of less than a micron if it is at least 10 times greater than the maximum height of the relief.

Also, in the embodiments, a continuous band-shaped resin sheet 125 is used, but it is possible to perform transfer molding of one semi-finished plate 146 (or multiple semi-finished plates 146) using a configuration in which the resin sheet 125 is strip-shaped and not continuous. In this case, it is sufficient that rollers and the like that can drive so as to rotate are arranged above and below and the like, thus making it possible to convey strip-shaped resin sheets 125 as well.

### Embodiment 7

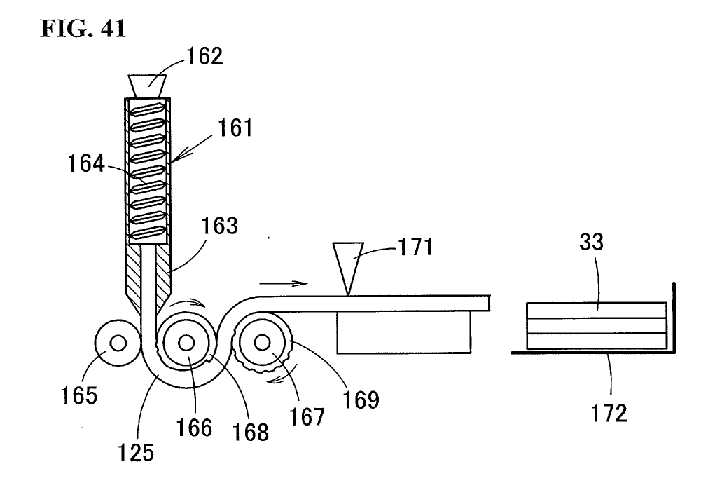

A light guide plate forming apparatus (transfer molding apparatus) that uses an extrusion molding machine will be described with reference to FIG. 41. An extrusion molding machine 161 may be a general-use extrusion molding machine, and includes a hopper 162 for introducing resin material (pellets), and a T-die 163. After being input into the hopper 162 and melting due to heating by a heater (not shown), the resin material is conveyed by a screw 164 and the resin sheet 125 is extruded continuously from the T-die 163. At this stage, the front and back faces of the resin sheet 125 are flat. The extruded resin sheet 125 passes between a roller 165 and a roller 166, and furthermore passes between the roller 166 and the roller 167. A stamper 168 is rolled on the outer circumferential face of the roller 166, and a reversed pattern for adding the inclined face 37 and the patterns to the upper face side of the light guide plate 33 are formed on the stamper 168. A stamper 169 is rolled onto the outer circumferential face of the roller 167, and an a reverse pattern for adding the pattern of the lower face side onto the light guide plate 33 is formed on the stamper 169.

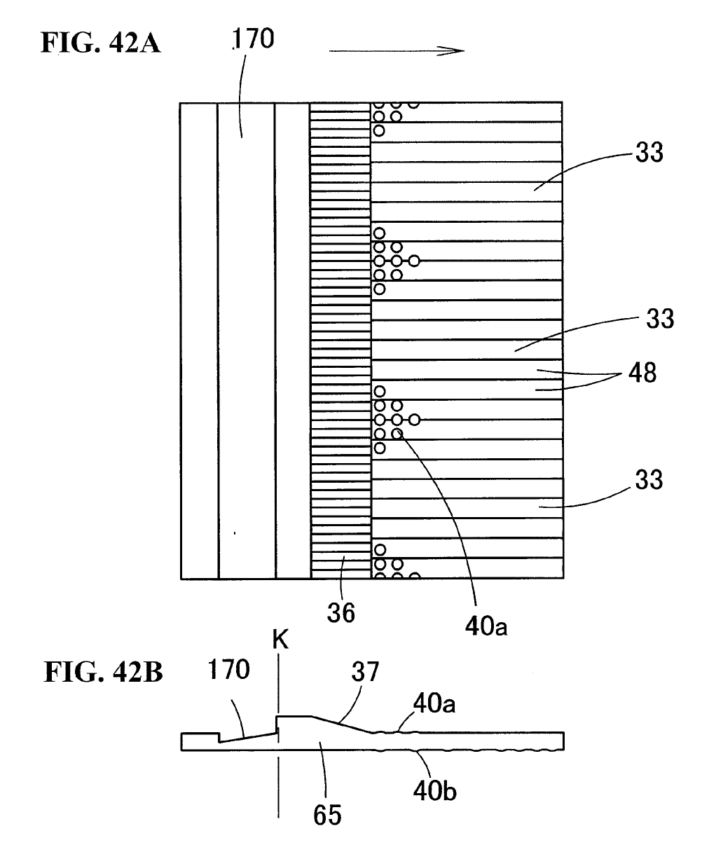

Thus, after being extruded from the extrusion molding machine 161, the resin sheet 125 is conveyed in the direction of the arrow in FIG. 42, and when passing between the roller 165 and the roller 166 as shown in FIG. 42, transfer molding of the protruding portion of the light introduction portion 35, the inclined face 37, the direction characteristic conversion pattern 36, the light emitting portions 40a, the lenticular lenses 48, and the like is performed on the upper face thereof. At this time, a recessed portion 170 is formed in the region adjacent to the protruding portion of the light introduction portion 35, and the melted resin that was extruded is supplied from the recessed portion 170 to the protruding portion of the light introduction portion 35. Next, when the resin sheet 125 passes between the roller 166 and the roller 167, transfer molding of the light emitting portions 40b and the like is performed on the lower face. After the patterns have been molded on the upper face and the lower face of the resin sheet 125 in this way, the resin sheet 125 is cut into forward, rear, left, and right light guide plate regions and light guide plates 33 by a cutter or a blade 171, and the finished light guide plates 33 are stacked in a stacker 172. In the cutting step, the rear portion of the light guide plate region is cut along the K line shown in FIG. 42B, and the portion of the recessed portion 170 is cut off. Note that the direction in which the resin sheet 125 is conveyed may be opposite that of the arrow shown in FIG. 42.

### Modified Example of Embodiment 7

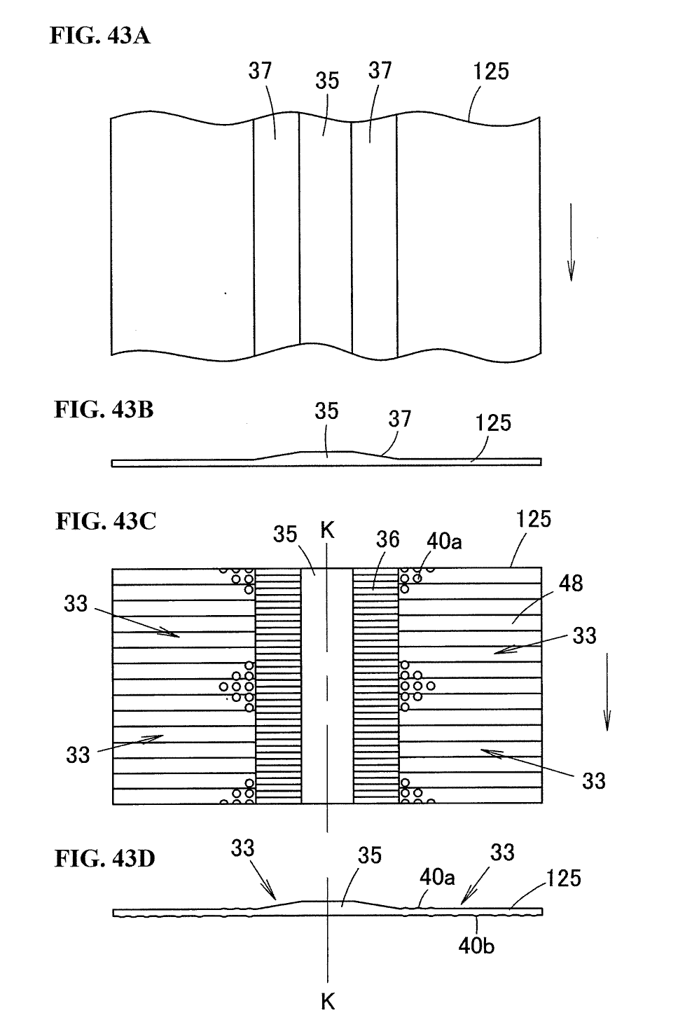

FIGS. 43A-D show a modified example of Embodiment 7 FIGS. 43A and 43B are a top view and a cross-sectional view of the resin sheet 125 that was extruded from the extrusion molding machine 161. In this modified example, a profile extrusion molding machine is used, and the protruding portions of two light introduction portions 35 are molded so as to be continuous on the resin sheet 125 that was extruded from the T-die 163 of the profile extrusion molding machine. Subsequently, as shown in FIGS. 43C and 43D, when the resin sheet 125 passes between the roller 165 and the roller 166, the direction characteristic conversion pattern 36, the light emitting portions 40a, the lenticular lenses 48, and the like are transferred and molded on the upper face, and when the resin sheet 125 passes between the roller 166 and the roller 167, the light emitting portions 40b and the like are transferred and molded on the lower face. After the patterns have been molded on the upper face and the lower face of the resin sheet 125 in this way, the resin sheet 125 is cut into forward, rear, left, and right light guide plate regions and light guide plates 33 by a cutter or a blade 171, and the manufactured light guide plates 33 are stacked in a stacker 172. In the cutting step, the center of the two light introduction portions 35 (K line) is cut.

### Embodiment 8

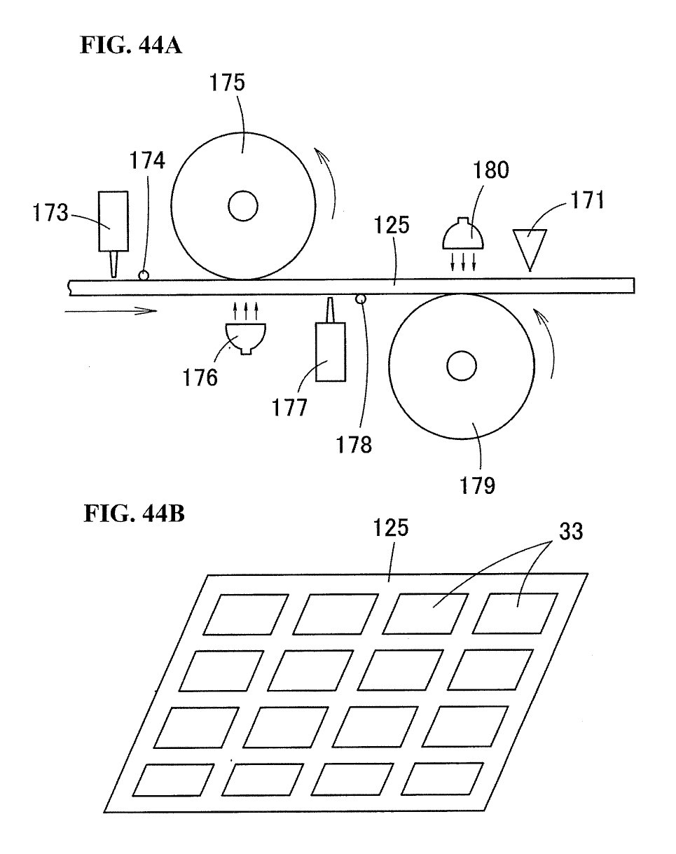

FIG. 44A is a schematic diagram for describing a transfer molding apparatus for a light guide plate using a double-sided roll 2P (photo polymerization) method. In the present embodiment, a supply nozzle 173 for supplying ultraviolet-curable resin 174 that has the same refractive index as the resin sheet 125 (e.g., the same resin) to the upper face of the resin sheet 125, a stamper roll mold 175 (transfer roll), and an ultraviolet radiation emission lamp 180 are arranged above the resin sheet path. Also, an ultraviolet radiation emission lamp 176, a supply nozzle 177 for supplying ultraviolet-curable resin 178 that has the same refractive index as the resin sheet 125 (e.g., the same resin) to the lower face of the resin sheet 125, and a stamper roll mold 179 (transfer roll) are arranged below the resin sheet.

Thus, upon the resin sheet 125 being conveyed thereto, an appropriate amount of ultraviolet-curable resin 174 is supplied from the supply nozzle 173 onto the upper face of the resin sheet 125, the ultraviolet-curable resin 174 is molded by the stamper roll mold 175, and the protruding portion of the light introduction portion 35, the inclined face 37, the direction characteristic conversion pattern 36, the light emitting portions 40a, and the like are formed on the upper face of the resin sheet 125. Next, an appropriate amount of the ultraviolet-curable resin 178 is supplied from the supply nozzle 177 onto the lower face of the resin sheet 125, the ultraviolet-curable resin 178 is molded by the stamper roll mold 179, and the light emitting portions 40b and the like are formed on the lower face of the resin sheet 125. Thus, multiple rows of light guide plates 33 are sequentially molded on the upper face and lower face of the resin sheet 125, as shown in FIG. 44B. Finally, the light guide plates 33 are cut away by the cutter or the blade 171.

Note that in the above-described transfer molding method (apparatus) for the light guide plate, a resin sheet is supplied between a first mold and a second mold and thereby transfer molding is performed on the resin sheet, but it is possible to perform transfer molding by supplying melted resin between the first mold and the second mold. For example, in the transfer molding apparatus 102 as shown in FIG. 27, it is envisioned that, instead of the resin sheet 125, melted resin is supplied between the lower mold transfer plate 114 and the upper mold transfer plate 120, and undergoes transfer molding by being sandwiched between the lower mold transfer plate 114 and the upper mold transfer plate 120. Also, in the transfer molding apparatus as shown in FIG. 41, the T-die 163 may be replaced with the roller 166 and the roller 167. In this case, after being extruded by the screw 164 of the extrusion molding machine 161, the melted resin is held between the stamper 168 that is wound around the roller 166, and the stamper 169 that is wound around the roller 167, and the melted resin undergoes transfer molding while remaining melted.

### Embodiment 9

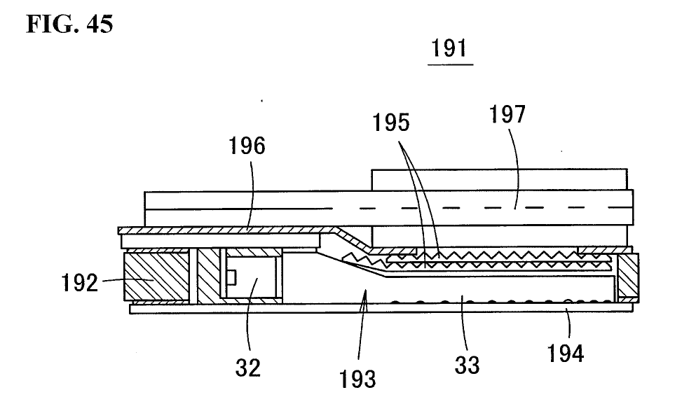

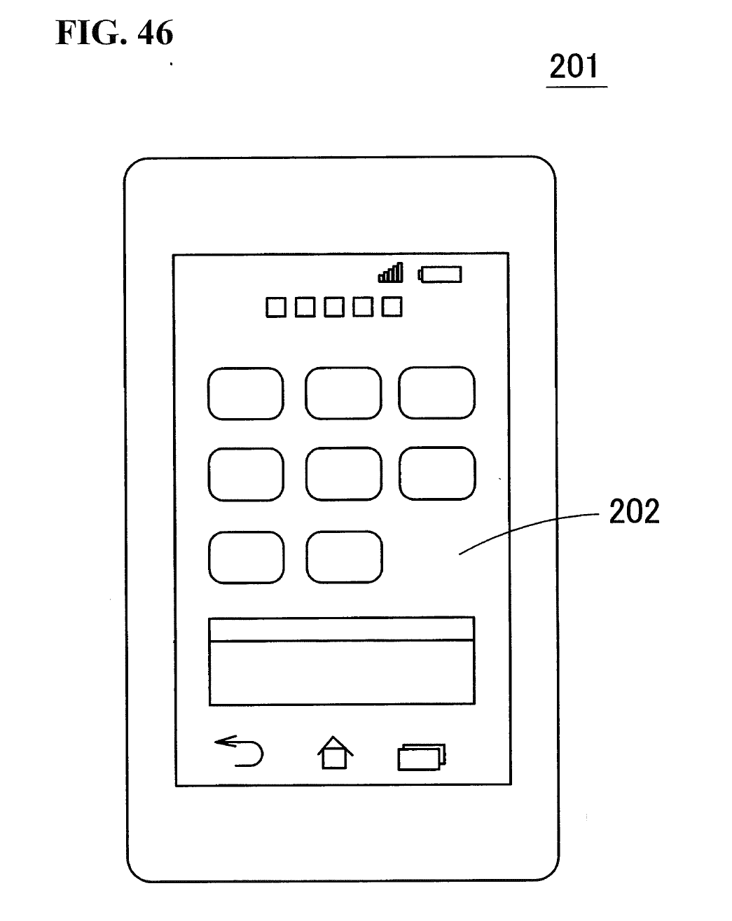

FIG. 45 is a schematic cross-sectional view showing the liquid crystal display apparatus 191 according to Embodiment 9 of the present invention. With the liquid crystal display apparatus 191, a planar light source apparatus 193 of one or more embodiments of the present invention that is composed of light sources 32 and a light guide plate 33 is enclosed in a frame 192, and a reflective sheet 194 such as a white resin sheet is provided on the lower face of the planar light source apparatus 193. Also, two prism sheets 195 are overlaid on the upper face of the light guide plate 33, and a black rim sheet 196 is overlaid thereupon. The rim sheet 196 opens in a location that corresponds to the light emission face of the light guide plate 33. The liquid crystal panel 197 is placed over the rim sheet 196. Accordingly, the planar light source apparatus 193 is a backlight that illuminates the liquid crystal panel 197 from behind.

### Embodiment 10

FIG. 46 is a plan view of a mobile device, or in other words, a smartphone 201 that uses the planar light source apparatus or the liquid crystal display apparatus of one or more embodiments of the present invention. A liquid crystal display apparatus 202 with a touch panel is included on the front face of the smartphone 201. Also, the planar light source apparatus of one or more embodiments of the present invention can be applied to mobile devices such as tablet-type computers, electronic dictionaries, and electronic book readers, in addition to mobile telephones such as smartphones.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A light guide plate transfer molding method for performing transfer molding of a light guide plate using a first mold and a second mold, the method comprising:
performing, on a resin material, transfer molding of a first pattern and a second pattern that are provided on a transfer face of the first mold,
wherein the first pattern changes with a specific interval P serving as one period, and
wherein the second pattern changes with one or two or more periods that correspond to 1.01/Na of the interval P,
where Na is a positive integer that satisfies Na≦m, m being a specific positive integer.

2. The light guide plate transfer molding method according to claim 1,
wherein among the first mold and the second mold, at least the first mold has a transfer face, and
wherein the transfer face has an area smaller than the area of the resin material.

3. The light guide plate transfer molding method according to claim 1, further comprising:
performing, on another surface of the resin material, transfer molding of a third pattern or a fourth pattern that are provided on the transfer face of the second mold,
wherein the third pattern changes with one or two or more periods that correspond to 1/Nb of the interval P,
where Nb is a positive integer that satisfies Nb≧m+1, m being a specific positive integer, and the fourth pattern not having periodicity.

4. The light guide plate transfer molding method according to claim 1,
wherein the period of the first pattern provided on the transfer face is the same as the period of the second pattern.

5. The light guide plate transfer molding method according to claim 4,
wherein the specific positive integer m is 1.

6. The light guide plate transfer molding method according to claim 1, further comprising:
supplying resin material to a position between a first mold and second mold that are arranged opposing each other; and
sandwiching the resin material between the two molds in a state in which the first mold and the second mold are pressed against the respective faces of the resin material.

7. The light guide plate transfer molding method according to claim 1, further comprising:
sequentially supplying resin material to a position that opposes a second mold and a position that opposes a first mold;
causing the first mold to be pressed against the resin material that was supplied to the position opposing the first mold, and
causing the second mold to be pressed against the resin material that was supplied to the position opposing the second mold.

8. The light guide plate transfer molding method according to claim 1,
wherein the resin material is a resin sheet that is molded in a sheet shape.

9. The light guide plate transfer molding method according to claim 1,
wherein the resin material is resin that has been applied to the surface of a resin sheet.

10. The light guide plate transfer molding method according to claim 1,
wherein the specific interval P is equal to the period with which the intensity of light incident on a light guide plate changes.

11. A light guide plate mold structure comprising:
a first mold comprising a transfer face; and
a second mold,
wherein a first pattern that changes with a specific interval P serving as one period, and a second pattern that changes with one or two or more periods that correspond to 1/Na of the interval P,
where Na is a positive integer that satisfies Na≦m, m being a specific positive integer, are provided on the transfer face formed on the first mold.

12. The light guide plate mold structure according to claim 11,
wherein a third pattern that changes with one or two or more periods that correspond to 1/Nb of the interval P,
where Nb is a positive integer that satisfies Nb≧m+1, m being a specific positive integer, and/or a fourth pattern that does not have periodicity are provided on a transfer face formed on the second mold.

13. A light guide plate transfer molding apparatus comprising the light guide plate mold structure according to claim 11.

14. The light guide plate transfer molding apparatus according to claim 13,
wherein the first mold is provided on the outer circumference of a first roller, and
wherein the second mold is provided on the outer circumference of a second roller.

15. A light guide plate comprising:
a light receiving face on which light is received on one end face, and
a light emission face that emits light received from the light receiving face to the exterior on a main face,
wherein a first pattern that appears on the surface in a cross-section taken parallel to the light receiving face and changes with a specific interval P serving as one period, and
wherein a second pattern that appears on the surface in a cross-section taken parallel to the light receiving face and changes with one or two or more periods that correspond to 1/Na of the interval P,
where Na is a positive integer that satisfies Na≦m, m being a specific positive integer, are provided on one of the upper face and the lower face in the vicinity of the light receiving face.

16. The light guide plate according to claim 15,
wherein a third pattern that appears on the surface in a cross-section taken parallel to the light receiving face and changes with one or two or more periods that correspond to 1/Nb of the interval P,
where Nb is a positive integer that satisfies Nb≧m+1, m being a specific positive integer, and/or a fourth pattern with no periodicity are provided on the other one of the upper face and the lower face.

17. A planar light source apparatus comprising:
a plurality of light sources arranged at a constant interval; and
a light guide plate comprising:
a light receiving face on which light is received on one end face, and
a light emission face that emits light received from the light receiving face to the exterior on a main face,
wherein a first pattern and a second pattern are provided on one face of an upper face and a lower face in the vicinity of the light receiving face of the light guide plate,
wherein the first pattern:
appears on the surface of the light guide plate in a cross-section taken parallel to the light receiving face of the light guide plate,
changes with a specific interval P of the plurality of light sources serving as one period, and
performs conversion of the direction characteristic of the light received from the light receiving face in the light guide plate in the thickness direction of the light guide plate into a direction characteristic inclined toward the width direction of the light guide plate, and
wherein the second pattern:
appears on the surface of the light guide plate in a cross-section taken parallel to the light receiving face of the light guide plate, and
changes with one or two or more periods that correspond to 1/Na of the arrangement interval P of the plurality of light sources,
where Na is a positive integer that satisfies Na≦m, m being a specific positive integer.

18. The planar light source apparatus according to claim 17,
wherein a third pattern that:
appears on the surface of the light guide plate in a cross-section taken parallel to the light receiving face of the light guide plate, and
changes with one or two or more periods that correspond to 1/Nb of the arrangement period P of the plurality of light sources,
where Nb is a positive integer that satisfies Nb≧m+1, m being a specific positive integer, is provided on the other face of the upper face and the lower face of the light guide plate.

19. The planar light source apparatus according to claim 17,
wherein a fourth pattern that appears on the surface of the light guide plate in a cross-section taken parallel to the light receiving face of the light guide plate and has no periodicity is provided on the other face of the upper face and the lower face of the light guide plate.

20. The planar light source apparatus according to claim 17,
wherein in a view from a direction perpendicular to the upper face of the light guide plate, the first pattern and the second pattern are provided in a region whose distance measured from the light receiving face is shorter than 3×P×√(n²−1).

21. The planar light source apparatus according to claim 17,
wherein in a view from a direction perpendicular to the upper face of the light guide plate, the first pattern and the second pattern are symmetrical with respect to the optical axis of each of the plurality of light sources within a range that is equal to the arrangement interval of the plurality of light sources.

22. The planar light source apparatus according to claim 17,
wherein the period of the first pattern is the same as the period of the second pattern.

23. The planar light source apparatus according to claim 22,
wherein the specific positive integer m is 1.

24. The planar light source apparatus according to claim 17,
wherein a fifth pattern that is arranged with a constant period is formed on the face of the light guide plate on the side on which the first pattern and the second pattern have been provided.

25. The planar light source apparatus according to claim 24,
wherein the fifth pattern is aligned with a period that is the interval P divided by an integer.

26. The planar light source apparatus according to claim 17,
wherein an irregularly-distributed fifth pattern is formed on the face of the light guide plate on the side on which the first pattern and the second pattern have been provided.

27. The planar light source apparatus according to claim 17,
wherein the light guide plate is constituted by a light introduction portion whose height dimension is the same as that of each of the plurality of light sources, and a light guide plate body that is thinner than the maximum thickness of the light introduction portion, is provided so as to be continuous with the light introduction portion, and emits received light to the exterior, and
wherein the light introduction portion has an inclined face that inclines as it extends from the surface of a portion that is thicker than the light guide plate body to the end of the surface of the light guide plate body, the inclined face being included on the face on the light emitting side of the light guide plate or on the face opposite thereto.

28. The planar light source apparatus according to claim 27,
wherein the inclined face of the light introduction portion is provided on the face on the light emitting side of the light guide plate,
wherein the first pattern is formed on at least a portion of the inclined face, and the second pattern is formed on the light guide plate body.

29. The planar light source apparatus according to claim 17,
wherein the first pattern forms a groove structure in which ridge lines and valley lines repeat alternatingly in the direction in which the plurality of light sources are aligned, and
wherein the first pattern includes an inclined face connecting a ridge line among the ridge lines and one of the valley lines adjacent to the ridge line, and an inclined face connecting the ridge line and the other valley line adjacent to the ridge line,
wherein, in a view in a cross-section obtained by cutting parallel to the light receiving face, the inclined faces are asymmetrical with respect to a straight line that passes through the ridge line and is perpendicular to the light emission face, and
wherein at least one set of the asymmetrical portions have different shapes on both sides of the center of a light source exists.

30. The planar light source apparatus according to claim 17,
wherein the rough density distribution of the second pattern is formed with a period at which the density is high at positions between the plurality of light sources when light is projected on the light receiving face.

31. The planar light source apparatus according to claim 17,
wherein a fifth pattern is provided on the emission face, and
wherein, in a view from the side face direction of the light guide plate that is parallel to the light receiving face, the fifth pattern is overlaid on at least a portion of the second pattern.

32. The planar light source apparatus according to claim 31,
wherein the fifth pattern has a lenticular lens shape.

33. The planar light source apparatus according to claim 31,
wherein the fifth pattern has a pattern shape.

34. A liquid crystal display apparatus constituted by the planar light source apparatus according to claim 20 and a liquid crystal panel.

35. A mobile device that includes the liquid crystal display apparatus according to claim 34.
